(19) United States
(12) Patent Application Publication
(10) Pub. No.: US 2024/0035869 A1
(43) Pub. Date: Feb. 1, 2024

(54) OIL AND GAS METERING SYSTEM

(71) Applicant: Johnson Controls Tyco IP Holdings LLP, Milwaukee, WI (US)

(72) Inventors: Kyle Shamrock, Glenview, IL (US); Tessa Anne Scott, Newtonhill (GB); Kenny Wallace, Milwaukee, WI (US)

(21) Appl. No.: 18/227,859

(22) Filed: Jul. 28, 2023

Related U.S. Application Data
(60) Provisional application No. 63/393,733, filed on Jul. 29, 2022.

(51) Int. Cl. G01F 15/06

(52) U.S. Cl. CPC G01F 15/068

(57) ABSTRACT

An oil and gas metering system may include an edge platform having at least one of a supervisory computer or a peripheral device that have one or more memory devices storing instructions thereon that, when executed by one or more processors, cause the one or more processors to receive a historical data values from an oil and gas metering subsystem, the historical data values having values of a plurality of data points for a plurality of historical times; evaluate the historical data values by at least one of the supervisory computer or the peripheral device to generate evaluation results; generate user interface data having at least one of the historical data values or the evaluation results; and transmit the user interface data. The system may include a cloud platform configured to receive the user interface data from the edge platform and provide the user interface data to a user device.

### CROSS-REFERENCE TO RELATED PATENT APPLICATIONS

This application claims the benefit of and priority to U.S. Provisional Patent Application No. 63/393,733 filed Jul. 29, 2022, the entire disclosure of which is incorporated by reference herein.

### BACKGROUND

The present disclosure relates generally to a metering system for oil and gas extraction and upstream processing. The present disclosure relates more particularly to a system for managing and processing data retrieved from equipment associated with the oil and gas extraction and upstream processing.

The oil and gas industry is heavily regulated with many reporting requirements and significant penalties or fines for performance violations. For example, basic reporting for emissions requires manual consolidation of paper and/or electronic logs. Performing on-site operations and maintenance tasks is also expensive and typically manual. Calibration of metering devices introduces substantial costs and may take several months. Typically, maintenance tasks for operating equipment are schedule-based (i.e., a schedule determines when the next maintenance is to be performed). Downtime during maintenance may be costly. Staffing oil and gas rigs (e.g., the oil and gas pieces of machinery located in the oil and gas drill sites or well sites) is costly and manual calibration/maintenance requires human staffing on-site. For example, frequently the oil and gas rigs are located in the ocean and/or in dangerous political zones. Additionally, transportation to the oil and gas site may also add to costs and the carbon footprint of calibration and maintenance. Measurement of liquid extraction and transfer is subject to error and dispute resolution can be costly.

### SUMMARY OF THE INVENTION

The present disclosure describes digitization of the oil and gas rigs by connecting metering devices to make data available in almost real-time and log historical data which will reduce manual tasks, calibration events, and fines as well as maintenance and operating tasks. More particularly, such digitization is described herein for upstream land and off-shore oil or gas production sites. More specifically digitization of flow meters, such as fuel meters, chromatography meters, and flare meters is described. Also, energy meters and other types of assets can be also digitized to achieve automatic and electronic monitoring and reporting of the emissions, proactively identifying critical events as well as to automate the meter checks.

One implementation of the present disclosure is an oil and gas metering system. The oil and gas metering system includes an edge platform including at least one of a supervisory computer or a peripheral device. The supervisory computer and/or the peripheral device include one or more memory devices storing instructions thereon. The instructions, when executed by one or more processors, cause the one or more processors to receive historical data values from an oil and gas metering subsystem. The historical data values include values of a plurality of data points for a plurality of historical times. The instructions further cause the one or more processors to evaluate the historical data values by at least one of the supervisory computer or the peripheral device to generate evaluation results, generate user interface data including at least one of the historical data values or the evaluation results, and transmit the user interface data. The oil and gas metering system further includes a cloud platform configured to receive the user interface data from the edge platform and provide the user interface data to a user device. The user interface data causes the user device to display a graphic representation of the oil and gas metering subsystem.

In some embodiments, evaluating the historical data includes generating a plurality of different operating scenarios for operating equipment of the oil and gas subsystem for the plurality of historical times and simulating a plurality of values of data points of the oil and gas subsystem for the plurality of historical times based on the plurality of different operating scenarios and the historical data values.

In some embodiments, evaluating the historical data includes generating a plurality of performance scores for a plurality of different operating scenarios based on at least one of the historical values of the plurality of data points or the evaluation results and determining a future recommendation for the oil and gas metering subsystem based on the plurality of performance scores for the plurality of different operating scenarios.

In some embodiments, the plurality of different operating scenarios include at least one of different control algorithms for the oil and gas metering subsystem, different control schedules for the oil and gas metering subsystem, installation of new equipment in the oil and gas metering subsystem, or maintenance of equipment for the oil and gas metering subsystem.

In some embodiments, evaluating the historical data values may include comparing a measured output of the historical data values with a desired output. In some embodiments, generating the user interface data may include issuing a notification in response to the measured output being at least three standard deviations from the desired output.

In some embodiments, evaluating the historical data values may include determining an uncertainty in an evaluation result of the evaluation results, identifying a plurality of data values of the historical data values that contribute to the evaluation result, and using an artificial intelligence model to determine which of the plurality of data values contributes most significantly to the uncertainty.

In some embodiments, evaluating the historical data values may include generating a recommendation based on the evaluation results, where the recommendation may include at least one of a recommendation to purchase and install a new control algorithm or a recommendation to purchase and install new equipment.

In some embodiments, evaluating the historical data values may include generating a recommendation based on the evaluation results, where the recommendation may include the recommendation to reduce production activities in response to a level of emissions exceeding an allowable limit. Implementations of the described techniques may include hardware, a method or process, or a computer tangible medium.

In one general aspect, method may include receiving, by an edge platform, the edge platform comprising at least one of a supervisory computer or a peripheral device, a historical data values from an oil and gas metering subsystem, the historical data values having values of a plurality of data points for a plurality of historical times. The method may also include evaluating, by the edge platform, the historical data values by at least one of a supervisory computer or a peripheral device to generate evaluation results. The method may include generating, by the edge platform, user interface data having at least one of the historical data values or the evaluation results. The method may include transmitting, by the edge platform, the user interface data. The method may moreover include receiving, by a cloud platform, the user interface data from the edge platform and provide the user interface data to a user device, the user interface data causing the user device to display a graphic representation of the oil and gas metering subsystem.

Implementations may include one or more of the following features. The evaluating historical data values may include generating a plurality of different operating scenarios for operating equipment of the oil and gas subsystem for the plurality of historical times and simulating a plurality of values of data points of the oil and gas subsystem for the plurality of historical times based on the plurality of different operating scenarios and the historical data values.

In some embodiments, the evaluating the historical data values may include generating a plurality of performance scores for a plurality of different operating scenarios based on at least one of the historical data values of the plurality of data points or the evaluation results and determining a future recommendation for the oil and gas metering subsystem based on the plurality of performance scores for the plurality of different operating scenarios.

In some embodiments, the plurality of different operating scenarios include at least one of different control algorithms for the oil and gas metering subsystem, different control schedules for the oil and gas metering subsystem, installation of new equipment in the oil and gas metering subsystem, or maintenance of equipment for the oil and gas metering subsystem.

In some embodiments, evaluating the historical data values may include comparing a measured output of the historical data values with a desired output, where generating the user interface data may include issuing a notification in response to the measured output being at least three standard deviations from the desired output.

In some embodiments, evaluating the historical data values may include determining an uncertainty in an evaluation result of the evaluation results, identifying a plurality of data values of the historical data values that contribute to the evaluation result, and using an artificial intelligence model to determine which of the plurality of data values contributes most significantly to the uncertainty.

In some embodiments, evaluating the historical data values may include generating a recommendation based on the evaluation results, where the recommendation may include at least one of a recommendation to purchase and install a new control algorithm or a recommendation to purchase and install new equipment.

In some embodiments, the evaluating the historical data values may include generating a recommendation based on the evaluation results, where the recommendation may include the recommendation to reduce production activities in response to a level of emissions exceeding an allowable limit.

In one general aspect, one or more non-transitory computer readable media containing program instructions may include receiving, by an edge platform, the edge platform comprising at least one of a supervisory computer or a peripheral device, a historical data values from an oil and gas metering subsystem, the historical data values having values of a plurality of data points for a plurality of historical times. In some embodiments, the one or more non-transitory computer readable media containing program instructions may also include evaluating, by the edge platform, the historical data values by at least one of a supervisory computer or a peripheral device to generate evaluation results. Instructions may furthermore include generating, by the edge platform, user interface data having at least one of the historical data values or the evaluation results. Instructions may in addition include transmitting, by the edge platform, the user interface data. Instructions may moreover include receiving, by a cloud platform, the user interface data from the edge platform and provide the user interface data to a user device, the user interface data causing the user device to display a graphic representation of the oil and gas metering subsystem.

Implementations may include one or more of the following features. In some embodiments, evaluating historical data values may include generating a plurality of different operating scenarios for operating equipment of the oil and gas subsystem for the plurality of historical times and simulating a plurality of values of data points of the oil and gas subsystem for the plurality of historical times based on the plurality of different operating scenarios and the historical data values.

In some embodiments, evaluating the historical data values may include generating a plurality of performance scores for a plurality of different operating scenarios based on at least one of the historical data values of the plurality of data points or the evaluation results and determining a future recommendation for the oil and gas metering subsystem based on the plurality of performance scores for the plurality of different operating scenarios.

In some embodiments, the evaluating the historical data values may include comparing a measured output of the historical data values with a desired output, where generating the user interface data may include issuing a notification in response to the measured output being at least three standard deviations from the desired output.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of oil and gas metering system, according to an exemplary embodiment.

FIGS. 2A-2B are schematic drawings of a graphical user interface including an operational overview of emissions reporting for a historical time at an oil and gas site, according to an exemplary embodiment.

FIG. 3 is a schematic drawing of a graphical user interface including a reconciliation of emissions reporting to other systems of record for a historical time at the oil and gas site based on the source of emissions, according to an exemplary embodiment.

FIG. 4 is a schematic drawing of a graphical user interface including a summary of condition-based maintenance for a historical time in a portion of the oil and gas subsystem, according to an exemplary embodiment.

FIG. 5 is a schematic drawing of a graphical user interface including functional diagnostics for metering the condition-based maintenance for a historical time in a portion of the oil and gas subsystem, according to an exemplary embodiment.

FIG. 6 is a schematic drawing of a graphical user interface including system integrity and process conditions for metering the condition-based maintenance for a historical time in a portion of the oil and gas subsystem, according to an exemplary embodiment.

FIGS. 7A-7B are schematic drawings of a graphical user interface including data points of metering various parameters for a historical time in a portion of the oil and gas subsystem, according to an exemplary embodiment.

FIG. 8 is a block diagram of oil and gas metering system, according to an exemplary embodiment.

FIGS. 9A-9B are schematic drawings of a graphical user interface including data points of metering various parameters for a historical time in a portion of the oil and gas subsystem, according to an exemplary embodiment.

FIG. 10 is a schematic drawing of a graphical user interface including data points of metering various parameters for a historical time in a portion of the oil and gas subsystem, according to an exemplary embodiment.

FIG. 11 is a schematic drawing of a graphical user interface including data points of metering various parameters for a historical time in a portion of the oil and gas subsystem, according to an exemplary embodiment.

FIG. 12 is a schematic drawing of a graphical user interface including data points of metering various parameters for a historical time in a portion of the oil and gas subsystem, according to an exemplary embodiment.

FIG. 13 is a schematic drawing of a graphical user interface including data points of metering various parameters for a historical time in a portion of the oil and gas subsystem, according to an exemplary embodiment.

FIG. 14 is a schematic drawing of a graphical user interface including data points of metering various parameters for a historical time in a portion of the oil and gas subsystem, according to an exemplary embodiment.

FIG. 15 is a schematic drawing of a graphical user interface including data points of metering various parameters for a historical time in a portion of the oil and gas subsystem, according to an exemplary embodiment.

FIGS. 16A-16C are schematic drawings of a graphical user interface including data points of metering various parameters for a historical time in a portion of the oil and gas subsystem, according to an exemplary embodiment.

FIGS. 17A-17D are schematic drawings of a graphical user interface including data points of metering various parameters for a historical time in a portion of the oil and gas subsystem, according to an exemplary embodiment.

FIG. 18 is a schematic drawing of a graphical user interface including data points of metering various parameters for a historical time in a portion of the oil and gas subsystem, according to an exemplary embodiment.

FIG. 19 is a schematic drawing of a graphical user interface including data points of metering various parameters for a historical time in a portion of the oil and gas subsystem, according to an exemplary embodiment.

FIG. 20 is a schematic drawing of a graphical user interface including data points of metering various parameters for a historical time in a portion of the oil and gas subsystem, according to an exemplary embodiment.

FIGS. 21A-21D are schematic drawings of a graphical user interface including data points of metering various parameters for a historical time in a portion of the oil and gas subsystem, according to an exemplary embodiment.

FIG. 22 is a schematic drawing of a graphical user interface including data points of metering various parameters for a historical time in a portion of the oil and gas subsystem, according to an exemplary embodiment.

### DETAILED DESCRIPTION

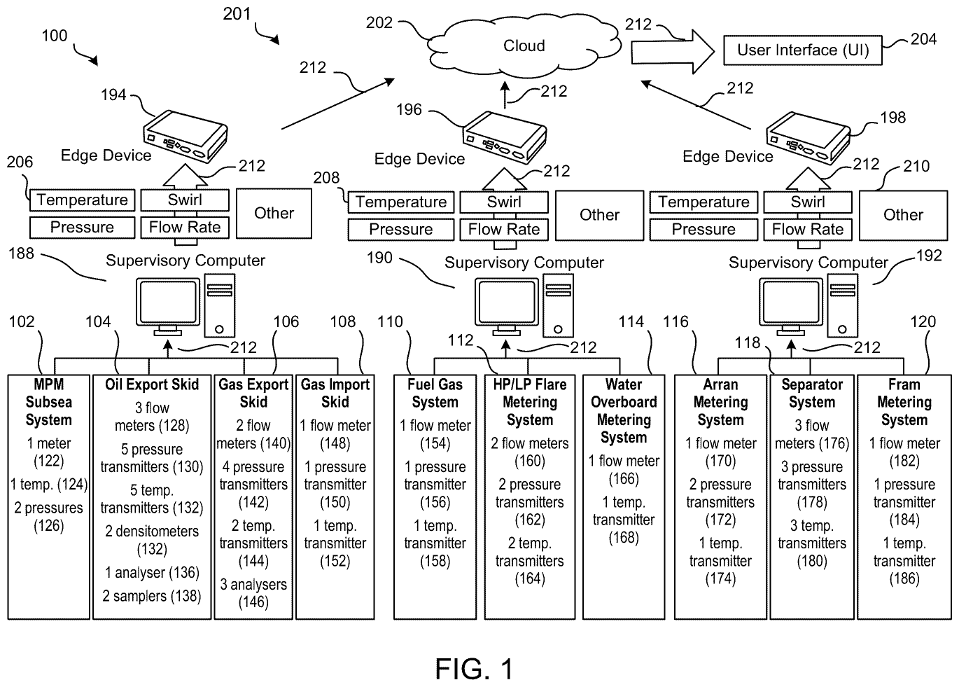

Referring generally to the FIGURES, systems and methods for an oil and gas metering system 100 are illustrated. As shown in FIG. 1, the oil and gas metering system 100 includes a multi-phase meter (MPM) subsea system 102, an oil export skid 104, a gas export skid 106, a gas import skid 108, a fuel gas system 110, high pressure and/or low pressure (HP/LP) flare meters or metering systems 112, water overboard meters or metering systems 114, an arran meter or metering system 116, a separator system or separator 118, and a fram meter or metering system 120. The arrangement of the oil and gas metering system 100 is exemplary. In some embodiments, more, less, or different subsystems may be included. The configuration of the oil and gas metering system 100 can vary.

The MPM subsea system 102 is disposed below a sea level and located at a drill site or well site where oil and natural gas is being extracted from the ground. The metering devices of MPM subsea system 102 measure the flow and conditions of the material coming out of the ground. The MPM subsea system 102 includes metering devices and sensors. In some embodiments, the MPM subsea system 102 includes a multi-phase meter 122, a temperature sensor 124, and a pressure sensor 126. In some embodiments, the MPM subsea system 102 includes more than one temperature sensor 124. In some embodiments, the MPM subsea system 102 includes more than one multi-phase meter 122 and/or more than one pressure sensors 126. For example, in some embodiments, the MPM subsea system 104 may include two pressure sensors 126.

The oil export skid 104 includes metering devices and sensors. In some embodiments, the oil export skid 104 includes a flow meter 128, a pressure transmitter 130, a temperature transmitter 132, a densitometer 134, an analyzer 136, and a sampler 138. The metering devices and sensors 128 through 138 of oil export skid 104 measure parameters during the transfer of custody of oil. In some embodiments, the oil export skid 104 includes more than one flow meter 128, more than one pressure transmitter 130, more than one temperature transmitter 132, more than one densitometer 134, more than one analyzer 136, and more than one sampler 138. For example, in some embodiments, the oil export skid 104 may include three flow meters 128, five pressure transmitters 130, five temperature transmitters 132, two densitometers 134, one analyzer 136, and two samplers 138.

The gas export skid 106 includes metering devices and sensors. In some embodiments, the gas export skid 106 includes a flow meter 140, a pressure transmitter 142, a temperature transmitter 144, and an analyzer 146. The metering devices and sensors 140 through 146 of the gas export skid 106 measure parameters during the transfer of custody of gas. In some embodiments, more than one flow meter 140, more than one pressure transmitter 142, more than one temperature transmitter 144, and more than one analyzer 146. For example, in some embodiments, the gas export skid 106 may include two flow meters 140, four pressure transmitters 142, two temperature transmitters 144, and three analyzers 146.

The gas import skid 108 includes metering devices and sensors. In some embodiments, the gas import skid 108 includes a flow meter 148, a pressure transmitter 150, and a temperature transmitter 152. In some embodiments, more than one flow meter 148, more than one pressure transmitter 150, and more than one temperature transmitter 152.

The fuel gas system 110 includes metering devices and sensors. In some embodiments, the fuel gas system 110 includes a flow meter 154, a pressure transmitter 156, and a temperature transmitter 158. In some embodiments, the fuel gas system 110 may include more than one flow meter 154, more than one pressure transmitter 156, and more than one temperature transmitter 158.

The high and low flow pressure (HP/LP) flare metering system 112 includes metering devices and sensors. The metering devices and sensors of the HP/LP flare metering system 112 measure parameters during expelling oil and gas into the air. In some embodiments, the HP/LP flare metering system 112 includes a flow meter 160, a pressure transmitter 162, and a temperature transmitter 164. In some embodiments, the HP/LP flare metering system 112 may include more than flow meter 160, more than one pressure transmitter 162, and more than one temperature transmitter 164. For example, in some embodiments, the HP/LP flare metering system 112 may include two flow meters 160, two pressure transmitters 162, and two temperature transmitters 164. In some embodiments, the metering devices and sensors of high and low pressure (HP/LP) flare metering system 112 are configured to control both high and low pressure flares. Although HP/LP flare metering system 112 has been shown as integral system, high pressure (HP) and low pressure (LP) flare metering systems can be separate systems where the metering devices and sensors are configured to separately control high and low pressure flares, respectively. In some embodiments, HP/LP flare metering system 112 can be a hybrid system, where some metering devices and sensors are configured to control high and low pressure flares separately and some metering devices and sensors are configured to control both high and low pressure flares.

The water overboard metering systems 114 includes metering devices and sensors. The metering devices and sensors of the water overboard metering systems 114 measure parameters during injecting water back into a wellbore when oil is extracted. In some embodiments, the metering devices of the water overboard metering systems 114 include a flow meter 166 and a temperature transmitter 164. In some embodiments, the water overboard metering systems 114 may include more than one flow meter 166 and more than one temperature transmitter 164.

The arran metering system 116 includes metering devices and sensors. Arran can refer to a geographical location in Scotland, the U.K. In some embodiments, the arran metering system 116 used in gas field operations includes a flow meter 170, a pressure transmitter 172, and a temperature transmitter 174. In some embodiments, the arran metering system 116 may include more than one flow meter 170, more than one pressure transmitter 172, and more than one temperature transmitter 174. For example, in some embodiments, the arran metering system 116 may include one flow meter 170, two pressure transmitters 172, and one temperature transmitter 174.

The separator system 118 includes metering devices and sensors. In some embodiments, the separator system 118 includes a flow meter 176, a pressure transmitter 178, and a temperature transmitter 180. The metering devices of the separator system 118 measure parameters during separation of oil from water and gas. In some embodiments, the separator system 118 may include more than one flow meter 176, more than one pressure transmitter 178, and more than one temperature transmitter 180. For example, in some embodiments, the separator system 118 may include three flow meters 176, three pressure transmitters 178, and three temperature transmitters 180.

The fram metering system 120 includes metering devices and sensors. Fram can refer to a geographical location in England, the U.K. In some embodiments, the fram metering system 120 includes a flow meter 182, a pressure transmitter 184, and a temperature transmitter 186. In some embodiments, the fram metering system 120 may include more than one flow meter 182, more than one pressure transmitter 184, and more than one temperature transmitter 186. For example, in some embodiments, the fram metering system 120 may include one flow meter 182, seven pressure transmitters 184, and one temperature transmitter 186.

The metering devices 122 through 186 may have human-machine interfaces (e.g., panels for displaying parameters to users at an oil and gas site).

The oil and gas metering system 100 further includes a supervisory computer system that can include, for example, one or more supervisory computers 188, 190, and 192. The supervisory computer 188, 190, and 192 can be a general purpose or special purpose computer or other machine with a processor.

In some embodiments, the oil and gas metering system 100 further includes an edge platform 201 that in turn includes one or more peripheral devices 194, 196, and 198, and a cloud platform 202. The edge platform 201 and the cloud platform 202 can each be separate services deployed on the same or different computing systems. In some embodiments, the cloud platform 202 is implemented in off-premises computing systems (e.g., outside the oil and gas site). In some embodiments, the edge platform 201 is implemented on-premises (e.g., in the oil and gas site). In some embodiments, various data discussed herein may be processed at (e.g., processed using models executed at) the cloud platform 202 or other off-premises computing system/device or group of systems/devices, an edge or other on-premises system/device or group of systems/devices (e.g., the peripheral devices 194, 196, and 198), or a hybrid thereof in which some processing occurs off-premises and some occurs on-premises. In some example implementations, the data may be processed using systems and/or methods such as those described in U.S. patent application Ser. No. 17/710,458 filed Mar. 31, 2022, which is incorporated herein by reference in its entirety. In some embodiments, aspects of the systems 102-120 or other components may be incorporated into the cloud platform 202 (e.g., analytics, control of actuators, calibration of sensors or meters, etc.) or other network system(s). Additionally, in some embodiments, various data discussed herein may be stored in, retrieved from, or processed in the context of digital twins. In some such embodiments, the digital twins may be provided within an infrastructure such as those described in U.S. patent application Ser. No. 17/134,661 filed Dec. 28, 2020, 63/289,499 filed Dec. 14, 2021, and Ser. No. 17/537,046 filed Nov. 29, 2021, the entireties of each of which are incorporated herein by reference.

In some embodiments, edge devices including the peripheral devices 194, 196, and 198 can include inference engines that process information and reduce computational load on the cloud platform 202. In some embodiments, information is analyzed on the edge platform 201 using inference engines, then processed information is passed to the cloud platform 202. Distributed processing and inference engines can increase the reaction speed of the oil and gas metering system 100 at the edge, while reducing the computational load of the cloud platform 202 and increasing processing speed while reducing latency and bandwidth requirements for installation. In some embodiments, the artificial intelligence engine can be an inference engine. In the oil and gas industry, edge computing and edge located artificial intelligence can be advantageous because oil rigs and sites can often be located in remote locations where strong data connections may not be available and reducing the amount of information that must be transmitted provides advantages.

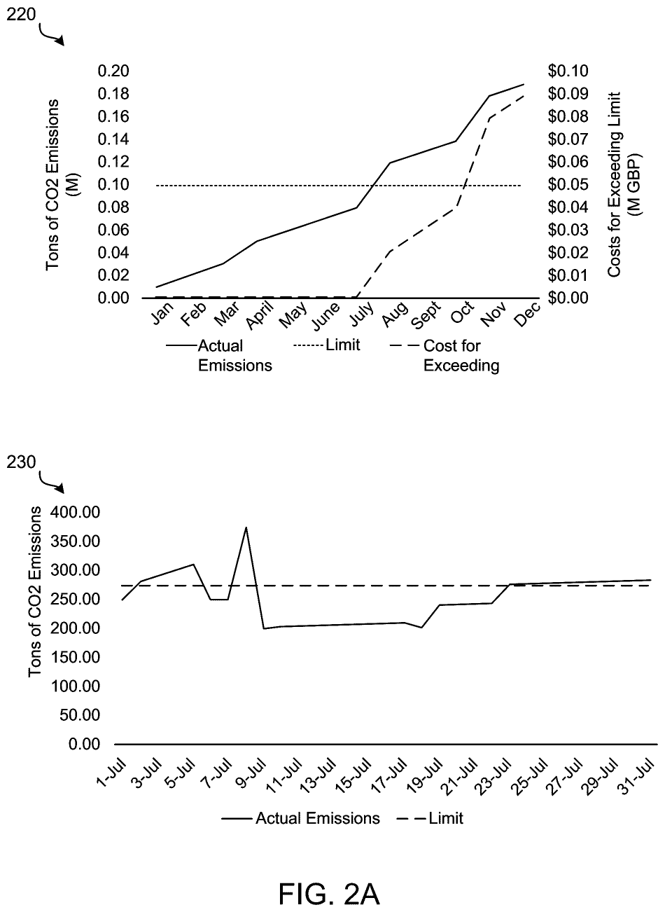

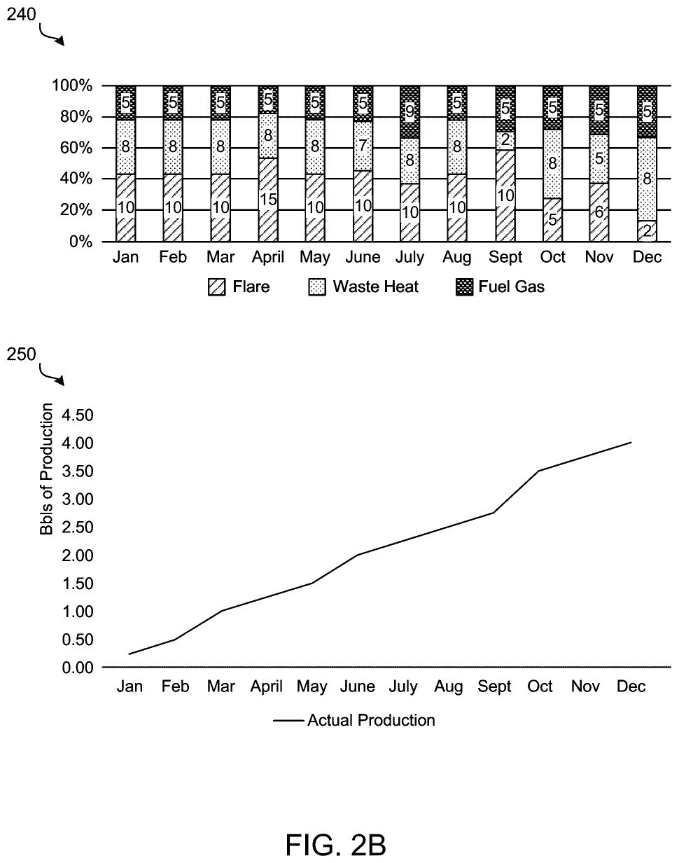

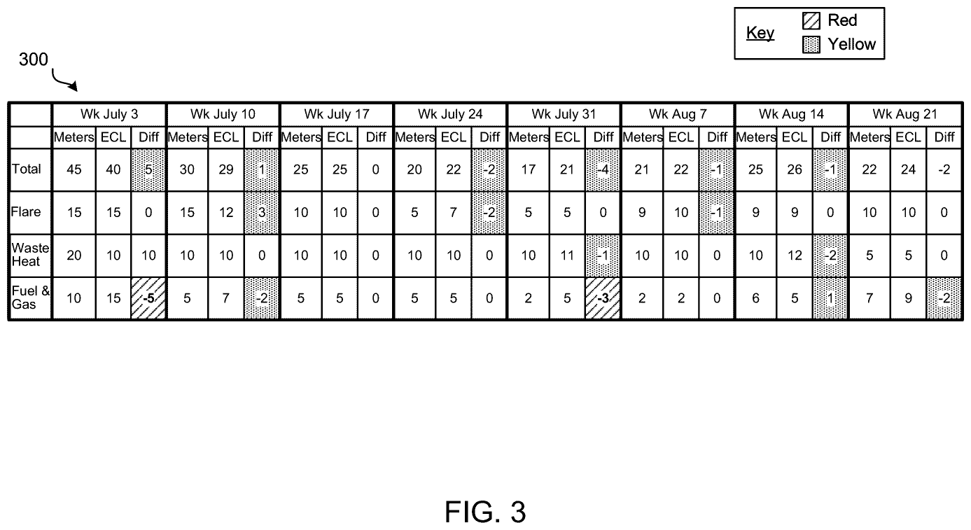

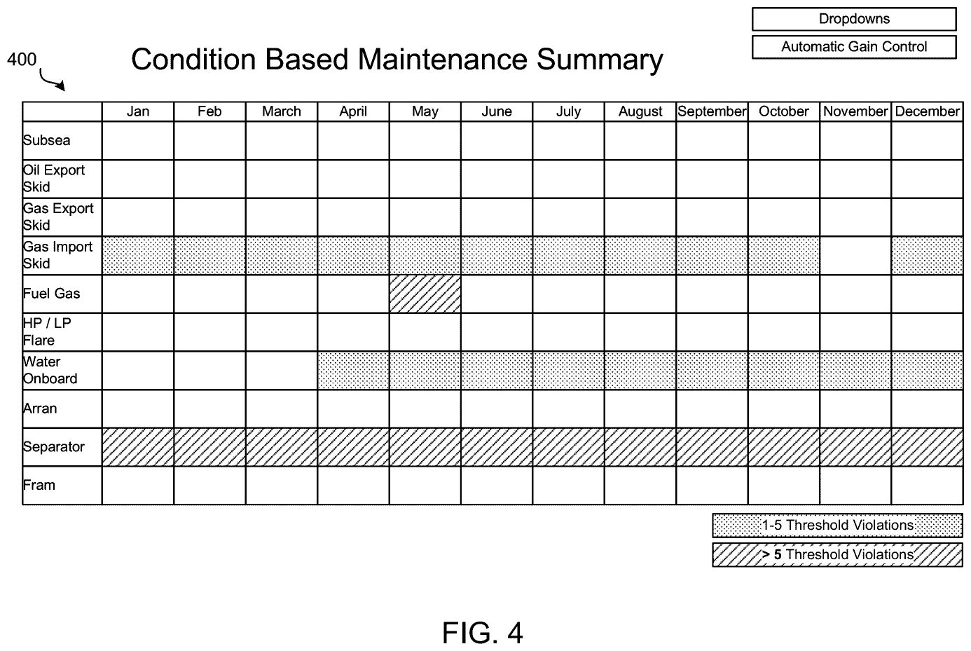

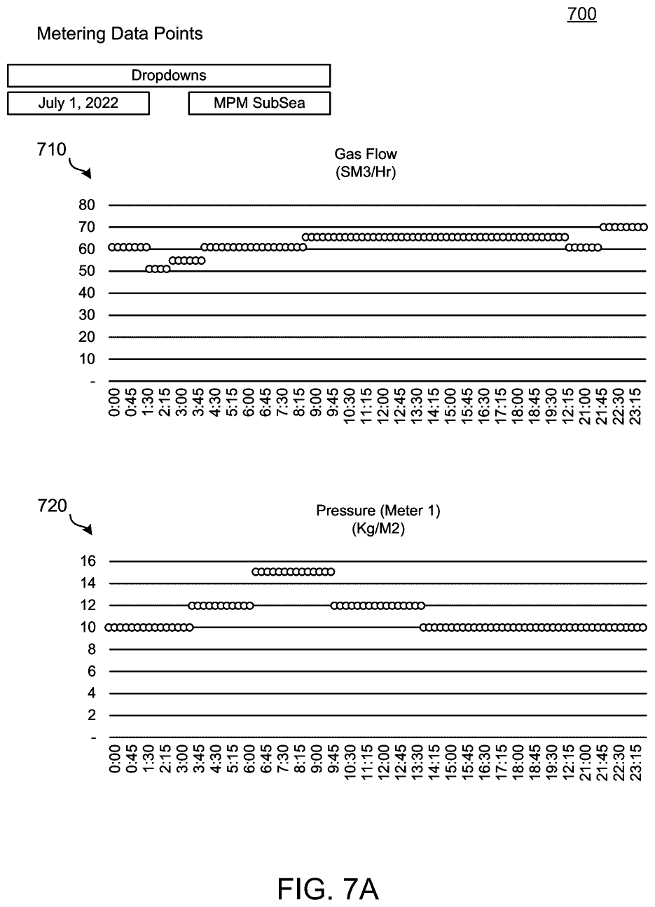

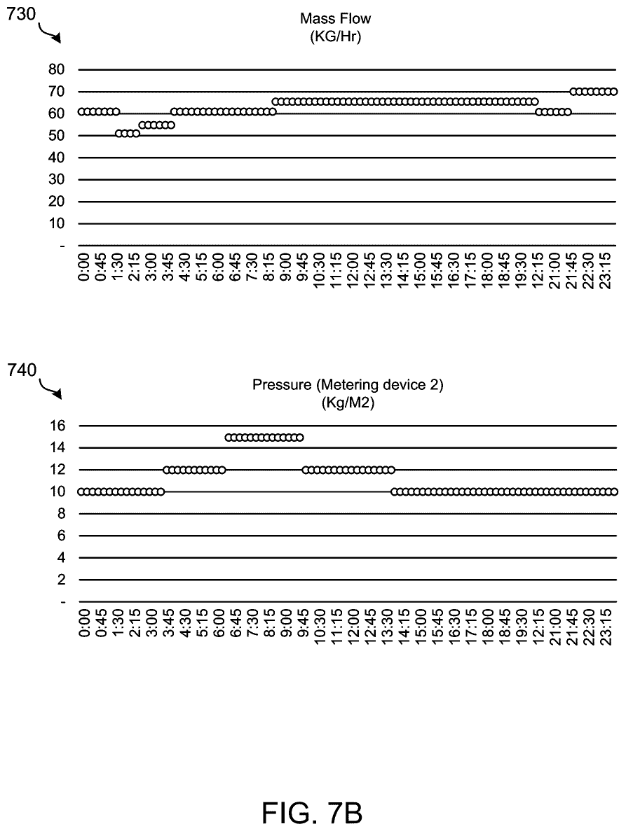

The oil and gas metering system 100 includes applications and a User Interface (UI) 204 on a user device. The applications can be various applications that operate to manage the parameters of the oil and gas subsystems 102 through 120. The applications can be remote or on-premises applications that run on various computing systems. The applications can include an emissions reporting application 200, 220, 230, 240, 250 (FIGS. 2-3) configured to manage emissions reporting for the oil and gas subsystems 102 through 120. The applications include a maintenance application 400, 510, 520, 530, 540, 610, 620, 630, 640 (FIGS. 4-6) that facilitates decision-making of a user, for example, to request a type and timing of the maintenance, for example, a condition-based service for the oil and gas subsystems 102 through 120. In some embodiments, the applications include a metering application 710, 720, 730, 740 (FIG. 7) configured to meter various parameters of the oil and gas subsystems 102 through 120. The metering application 710, 720, 730, 740 can be configured to automate and digitize such parameters of the oil and gas subsystems 102 through 120 as, for example, gas flow, pressure, mass flow, and others.

In some embodiments, the applications and/or the cloud platform 202 interacts with a user device. In some embodiments, a component or an entire application of the applications runs on the user device. The user device may be a laptop computer, a desktop computer, a smartphone, a tablet, a virtual reality device (e.g., a virtual reality headset or helmet), an augmented reality device (e.g., an augmented reality headset or helmet), and/or any other device with an input interface (e.g., touch screen, mouse, keyboard, etc.) and an output interface (e.g., a speaker, a display, etc.). In some embodiments, the user device includes communication protocols that allow for automatic or automated interaction with components of the oil and gas metering system 100. For example, the user device can include a near field communication system that automatically connects to sensors, meters, valves or other devices or components when a user is within a predetermined distance or range from the device. In some embodiments, a virtual or augmented reality interface can be presented to the user via the user device to automatically provide relevant information. For example, a valve throughput, position, or status may be displayed automatically when a user looks at a valve. Similarly, production and or emissions information can be presented automatically based on a user's geographic location, or location relative to components of interest. In some embodiments, the user device presents a virtual reality environment to the user so that the user can experience the oil and gas metering system 100 in a virtual environment. For example, the cloud platform 202 may include a digital twin of the oil and gas metering system 100 and the user can access, tour, inspect, or otherwise interact with the digital twin of the oil and gas metering system 100 using the virtual reality user interface running the applications.

The applications, the cloud platform 202, and the edge platform 201 can be implemented on one or more computing systems, e.g., on processors and/or memory devices. For example, the edge platform 201 includes processor(s) and memories, and the cloud platform 202 includes processor(s) and memories, the applications include processor(s) and memories.

The processors can be a general purpose or specific purpose processor, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.).

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicatively connected to the processors and can include computer code for executing (e.g., by the processors) one or more processes described herein.

The edge platform 201 that includes edge devices 194, 196, and 198 can be configured to provide connection to the supervisory computers 188, 190, and 192 that are further communicatively coupled to the oil and gas subsystems 102 through 120. Thus, the edge platform 201 can receive messages from the oil and gas subsystems 102 through 120 and/or deliver messages to the oil and gas subsystems 102 through 120. The edge platform 201 includes one or multiple gateways, e.g., edge devices 194, 196, and 198. The edge or bridge devices 194, 196, and 198 can act as a gateway between the cloud platform 202 and the supervisory computers 188, 190, and 192 that are communicatively coupled to the oil and gas subsystems 122. In some embodiments, the applications can be deployed on the edge platform 201, e.g., on the bridge devices 194, 196, and 198. In this regard, lower latency in management of the oil and gas subsystems 102 through 120 can be realized. The bridge devices 194, 196, and 198 may include any number of edge sensors, computing devices, servers, etc.

The edge platform 201 can be connected to the cloud platform 202 via a network 212. The network 212 can communicatively couple the devices and systems of oil and gas metering system 100. In some embodiments, the network 212 is at least one of and/or a combination of a Wi-Fi network, a wired Ethernet network, a ZigBee network, a Bluetooth network, and/or any other wireless network. The network 212 may be a local area network or a wide area network (WAN) (e.g., the Internet, an oil and gas WAN, etc.) and may use a variety of communications protocols (e.g., Building Automation Control network, Internet Protocol, Local Operating Network, etc.). The network 212 may include routers, modems, servers, cell towers, satellites, and/or network switches. The network 212 may be a combination of wired and wireless networks.

The cloud platform 202 can be configured to facilitate communication and routing of messages between the applications, the edge platform 201, and/or any other system. The cloud platform 202 can include a platform manager, a messaging manager, and a command processor. In some embodiments, the cloud platform 202 can facilitate messaging between the oil and gas metering system 100 via the network 212.

The messaging manager can be configured to operate as a transport service that controls communication with the oil and gas subsystems 102 through 120 and/or any other system, e.g., managing commands to devices (C2D), commands to connectors (C2C) for external systems, commands from the device to the cloud (D2C), and/or notifications. The messaging manager can receive different types of data from the applications and/or the edge platform 201. The messaging manager can receive change on value data, e.g., data that indicates that a value of a point has changed. The messaging manager can receive timeseries data, e.g., a time correlated series of data entries each associated with a particular time stamp. Furthermore, the messaging manager can receive command data. All of the messages handled by the cloud platform 202 can be handled as an event, e.g., the data can each be packaged as an event with a data value occurring at a particular time (e.g., a temperature measurement made at a particular time).

The cloud platform 202 includes a command processor. The command processor can be configured to receive commands to perform an action from the applications, the oil and gas subsystems 102 through 120, the user device, etc. The command processor can manage the commands, determine whether the commanding system is authorized to perform the particular commands, and communicate the commands to the commanded system, e.g., the oil and gas subsystems 102 through 120 and/or the applications. The commands could be a command to change an operational setting that controls parameters of the oil and gas subsystems 102 through 120, a command to run analytics, etc. Further, these systems and methods may include cloud-to-cloud integration for receiving data from external sources, such as weather services. In this example, weather data may be utilized to determine an impact to production schedule of the oil and gas site, such as delays due to inclement weather.

The oil and gas subsystems 102 through 120 are communicatively coupled to one or more of the supervisory computers 188, 190, and 192. More particularly, the MPM subsea system 104, the oil export skid 104, the gas export skid 106, and the gas import skid 108 are communicatively coupled to the supervisory computer system 188. The fuel gas system 110, the HP/LP flare metering system 112, and the water overboard metering system 114 are communicatively coupled to the supervisory computer system 190. The arran metering system 116, the separator system 118, and the fram metering system 120 are communicatively coupled to the supervisory computer system 192.

The communication between the metering devices 122 through 186 and the supervisory computers 188, 190, and 192 may be performed via one or more integration protocols. The supervisory computers 188, 190, and 192 transmit a signal to one or more of the bridge devices 194, 196, and 198 where such signal represents one or more parameters within a data set 206, 208, and 210 ingested by one or more metering devices 122 through 186 included into one or more of the oil and gas subsystem 102 through 120. The parameters can be a temperature, a swirl, a pressure, a flow rate, and other values ingested by the sensors or the devices 122 through 186 of the oil and gas subsystems 102 through 120. The peripheral bridge devices 194, 196, and 198 transmit the signal representing the parameters to cloud 202 that transmits the parameters to the user interface (UI) 204 to present to a user in a form of charts, trends, alerts and industry performance metrics. For example, the parameters from the data sets 206, 208, and 210 can be presented in a form of charts, trends, metrics, alerts, etc. illustrated in FIGS. 2-7.

Referring now to FIGS. 2 through 7, schematic drawings of graphical user interface (UI) 204 including tracking various metrics are illustrated. In one of the embodiments, the oil and gas metering system 102 may be used for emissions management and reporting, for example, to automatically and electronically monitor and log emissions. For example, referring to FIGS. 2-3, emissions reporting operational overview and emissions reporting reconciliation are illustrated, respectively. For example, FIGS. 2A-2B illustrate schematic drawings of the graphical user interface including an operational overview of emissions reporting for a historical time in a portion of the oil and gas subsystem, according to some embodiments.

For example, a graph 220 represents a mass of CO2 emissions (measured in tons) and costs for exceeding limit as well as the limit of CO2 emissions for a historical time at the oil and gas site, according to some embodiments. A graph 230 represents a mass of CO2 emissions (measured in tons) and the limit of CO2 emissions for a historical time at the oil and gas site, according to some embodiments. A graph 240 represents a relative contributor or source (e.g., flare, waste heat, or fuel gas) to the total volume of CO2 emissions for a historical time at the oil and gas site, according to some embodiments. A graph 250 represents an actual volume of production for a historical time at the oil and gas site, according to some embodiments. Any of the graphs 220 through 250 may represent the individual oil and gas subsystem 102 through 120 or only a portion of the oil and gas subsystem 102 through 120.

In some embodiments, an alert signal may be sent to the user if percentage of emissions change deviates by a threshold value, range, or a hysteresis band (e.g., +/−5%) of the production percentage change. Optionally or alternatively, the alert signal may be sent to the user if a source of emissions mix shifts by a threshold value, range, or a hysteresis band (e.g +/−5%) from a trailing average value or range (e.g., a rolling 3-month average of the emissions sources). A source of emissions can be, for example, flare, waste heat, or fuel gas emitted by any oil and gas subsystem 102 through 120. In some embodiments, for example, in the graph 230, in FIG. 2, such the alarm signal may be transmitted to the user interface (UI) 204 when the actual emissions exceeded the limit during a predetermined time frame or date range (e.g., on July 1-July 5, July 8, July 23-July 31, etc.).

FIG. 3 illustrates a schematic drawing of the graphical user interface (UI) including a reconciliation 300 of emissions reporting for a historical time at the oil and gas site based on the source of emissions, according to some embodiments. The sources of emissions represented in FIG. 3 can be flare, waste heat, fuel gas or any other sources in the oil and gas subsystem 102 through 120. For each week or other time period, an actual value of emissions (or meter data) is in the first column of the respective time period, an expected credit loss (ECL) is in the second column, and the difference is in the third column. Weekly (or based on another time period) reconciliation of meter data and expected credit loss (ECL) reporting may be represented by highlighting the differences using one or more visual elements, e.g., representing the differences in a certain color: for example, yellow for a difference less than 50%; red for a difference greater than 50%. In some embodiments, other thresholds or values may be used.

The automatic and electronic monitoring and logging of emissions may be utilized to facilitate reporting and management in compliance with regulations established by government or other regulatory authority, for example, the UK/CE Emissions Trading Scheme (ETS). By monitoring and logging the parameters associated with the emissions provide an opportunity for a proactive action that will be discussed below and/or avoid penalties for non-compliance. In some embodiments, a user may take advantage of previous year off-sets for the emissions by monitoring emissions against historic averages and allowance limits. Some embodiments provide a reduced manual reporting effort such as, for example, associated with preparation and submitting an annual report for the emissions. In some embodiments, the following may be achieved by using the oil and gas metering system: optimized production planning, saved manual hours, availability of the verified records, removing or substantially reducing human errors, proactively addressing future expected regulations.

In various embodiments, the data output by the user interface (UI) 204 of the oil and gas metering system 100 is received from the actual production, for example, from multiple points where devices of the oil and gas subsystems 102 are disposed, such as flare, CO2 meters, waste heat recovery meters, and others. The oil and gas subsystem 100 may also provide a positive monetary impact, such as, for example, when the meter data is compared with the reporting system, e.g., with a hydrocarbon accounting system. Such data is typically entered into the hydrocarbon accounting system manually of via an expected credit loss (ECL) module. Using the oil and gas metering system 100 provides optimized production planning, saved manual hours, availability of the verified records, removing or substantially reducing human errors, proactively addressing future expected regulations.

Some embodiments of the oil and gas subsystem 100 may present the data in a form of trend charts and/or a comparison report of ECL system compared with the reports obtained from the metering devices. In some embodiments, as described herein, artificial intelligence (AI) may be utilized to capture increases in the emissions level or changes in the monitored parameters.

In some embodiments, the oil and gas metering system 100 executes an artificial intelligence agent to generate one or more inference values based on the one or more data points for one or more future times based on the historical data values. In some embodiments, the artificial agent is an agent for a specific oil and gas subsystem 102 through 120. For example, the agent could be an oil and gas subsystem history agent configured to evaluate the historical data of the oil and gas subsystem 102 through 120 and simulate a future data of the oil and gas subsystem 102-120 based on the historical data. Another agent could be a subsystem occupant prediction agent that is configured to predict the parameter (e.g., the temperature, the pressure, the swirl, the flow rate, etc.) of a particular metering device 122 through 186 of an oil and gas subsystem 102 through 120. Furthermore, the oil and gas metering system 100 may determine the inference and/or prediction values based on the other external data associated with the specific oil and gas site.

In some embodiments, the oil and gas metering system 100 executes an artificial intelligence agent to generate multiple different operating scenarios for operating equipment of the oil and gas subsystem for multiple historical times. More specifically, based on historical data values for the oil and gas subsystem 102 through 120, the model generates multiple operating scenarios of the oil and gas subsystem. For example, the model may generate an operating scenario that simulates one or more operations of the oil and gas subsystem 102 through 120. For example, the model may generate an operating scenario of a piece of equipment for the oil and gas subsystem 102 through 120 (e.g., installation and/or maintenance of equipment included in the oil and gas subsystem 102 through 120), a control algorithm or schedule for the oil and gas subsystem 102 through 120, or the operation of the oil and gas subsystem 102 through 120 as a whole.

In some embodiments, the emission score can be a score generated by an AI agent for various spaces of the oil and gas subsystem 102 through 120 based on measurements made for the various metering devices 122 through 186 of the oil and gas subsystem 102 through 120 and/or operating settings of other equipment included in the oil and gas subsystem 122 through 186. The emission score can be generated by the AI agent based on telemetry stored in a knowledge graph for the various spaces of the oil and gas subsystem 102 through 120. In other embodiments, the emission score may be generated using artificial intelligence executed by algorithms and/or software within the oil and gas metering system 100 (e.g., executed by an AI layer of the oil and gas metering system 100). The emission scores generated by the AI agent can be ingested by the AI agent into the knowledge graph.

In some embodiments, the oil and gas metering system 100 can be configured to query the knowledge graph for inferences, predictions, current data values, historical values, etc. The queries can be made for the various entities (e.g., equipment, such as for example, metering devices 122 through 186, the oil and gas subsystems 102 through 120, personnel, points of ingesting data, the oil and gas sites, etc.). Such entities may be viewed on the user interface (UI) 204 by the user via the user device. A data formatter can format the data queried from the knowledge graph into a format that can be displayed in a graphic subsystem. In some embodiments, the data needs to be translated from a JavaScript Object Notation (JSON) format to a Building Information Modeling (BIM) format. The data formatter can further generate graphics and configure the display of the graphics on the user interface (UI) 204 based on the values queried from the knowledge graph. The formatter can set colors, flow animations, historical trends, etc. of various data elements. In some embodiments, the AI agent can provide inferences recommendations and/or predictions for emissions score based on the parameters obtained from any of the oil and gas subsystem 102 through 120.

The emissions management and reporting system utilizing the oil and gas metering system 100 may provide production analysts visibility and actionable intelligence to manage production in order to reduce penalties and fines as well as to facilitate a more efficient compliance mechanisms. The oil and gas metering system 100 may provide a first report that illustrates a status of production and emissions wherein the data for this report may be pulled from an oil and gas site (that may be remote) and aggregated daily. In some embodiments, the first report of the oil and gas metering system 100 may summarize data for an oil and gas site by month and maintain cumulative amounts of the monitored parameters for a calendar year. In some embodiments, this report of the oil and gas metering system 100 may transmit alarm signals if there is a material deviation in emission rates and/or source of such emission.

The oil and gas metering system 100 may provide a second report that may reconcile the data obtained from the ECL reporting system with the data obtained from the metering devices. In some embodiments, the second report may be aggregated and reconciled daily and may have visual elements, e.g., highlighted fields in different colors for differences over a certain threshold value or percentage, for example, a first color (for example, yellow color) for difference less than 50% and a second color (for example, red color) is for difference equal or greater than 50%, as illustrated in FIG. 3.

In some embodiments, these and other capabilities of the oil and gas metering system 100 may be used to increase or decrease production at an oil and gas site based on emission status at such site. The oil and gas metering system 100, for example, may detect anomalies in emissions in respect to production and investigate the source(s) of such anomalies. In some embodiments, the oil and gas metering system 100 can ensure accuracy of the data that is reported under the ETS or other authority regulations.

Referring now to FIGS. 4-6, a summary of the condition-based maintenance is illustrated. In some embodiments, the condition-based maintenance may enable metering engineers to identify when a metering device needs to be removed and calibrated. FIG. 4 illustrates a schematic drawing of the graphical user interface including a summary of condition-based maintenance report for a historical time in a portion of the oil and gas subsystem 102 through 120, according to some embodiments.

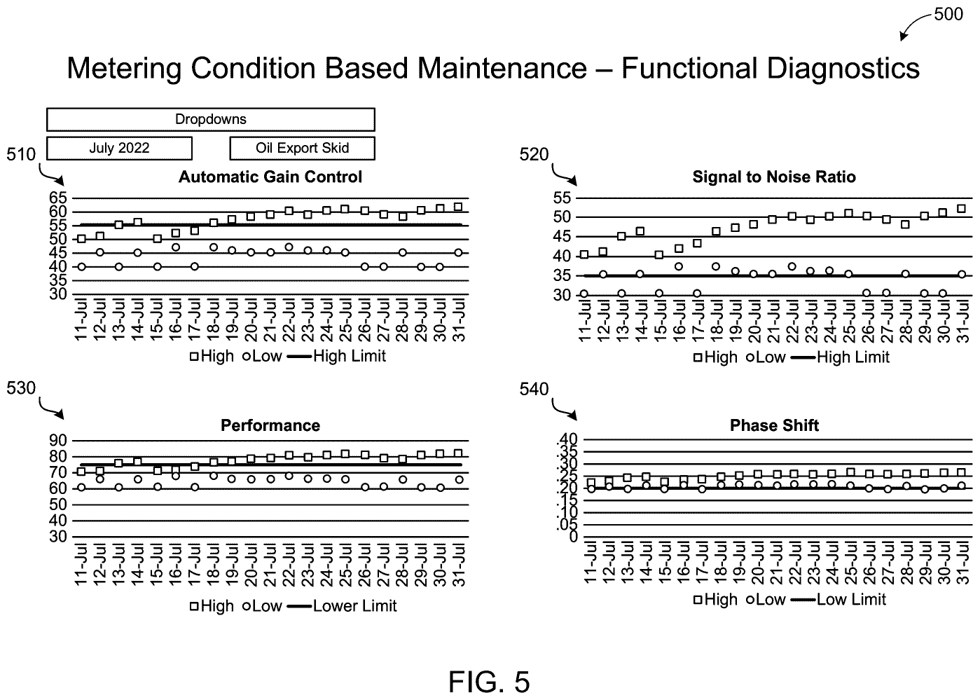

In FIG. 4, the fields not having any violations (e.g., in colors other than 1-5 threshold or greater than 5 violations) are shown not to require the maintenance based on the condition of a machinery, rather than the scheduled maintenance in certain intervals of time. A graph 400 illustrates a summary report that represents a cumulative number of times per each month when a metering segment violated test thresholds, for example, with drop downs to filter on a test. Display with a dropdown menu for an individual month at a time, e.g., July 2022, for the one meter segment or oil and gas subsystem 102 through 120, such as, for example, oil export skid 104 is illustrated in FIG. 5. For example, a graph 510 illustrates an automatic gain control. As illustrated in FIG. 4, the graph 400 is divided by a metering segment (e.g., representing the oil and gas subsystems 102 through 120) and aggregated by month. The report may utilize the following color-coding scheme to indicate number of violations: GREEN: no threshold violations; YELLOW: 1-5 Threshold Violations; RED: greater than 5 Threshold Violations. Therefore, for example, the oil and gas metering system 100 may provide information which metering devices 122 through 186 of the oil and gas subsystems 102 through 120 are functioning correctly and do not require action, such as maintenance, calibration, or anything else to bring the metering device 122 through 186 back to an operating condition. For example, in the graph 400 illustrated in FIG. 4, the most needed maintenance is required for the separator system 118 (FIG. 1).

Using the condition-based track performance of metering devices and proactively identifying metering drift can be facilitated by utilizing the oil and gas metering system 100 as shown in FIGS. 4-6. For example, reduced number of calibration events may be achieved by shifting performance tracking from schedule-based to condition-based maintenance as, for example, shown in FIG. 4, where the fields not having any violations (i.e., in colors other than 1-5 threshold or greater than 5 violations) do not require the maintenance based on the condition of the machinery, rather than the scheduled maintenance in certain intervals of time.

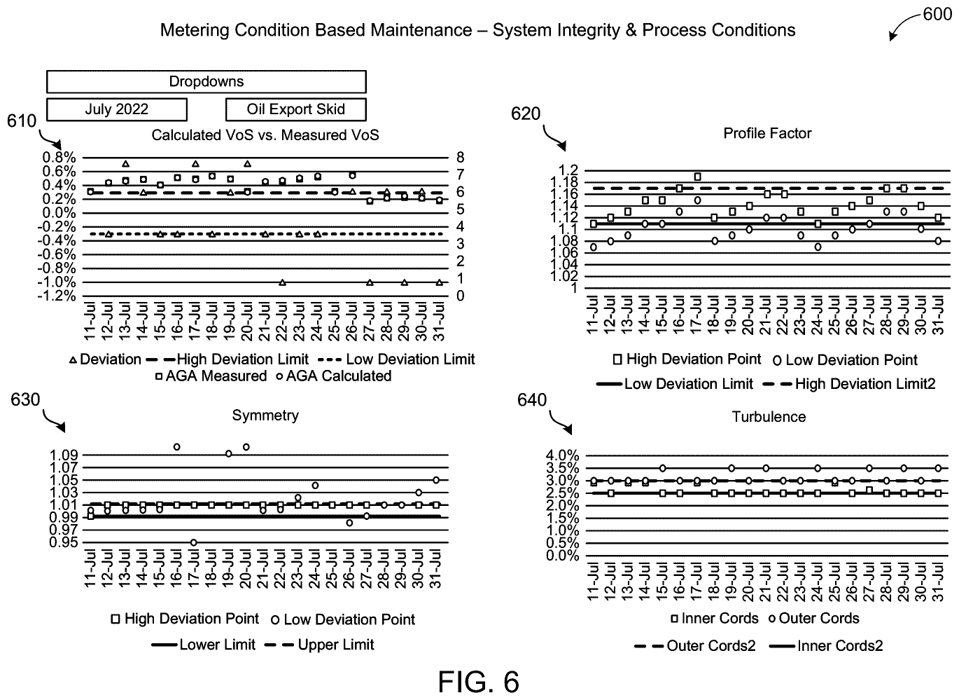

FIGS. 5-6 illustrate structures 500, 600 of the UI wireframe for the metering condition based maintenance, according to some embodiments. For example, the structures 500, 600 of the UI wireframe can include the detailed reports that show high and low points of each test filtered by month and by metering segment (e.g., the oil and gas subsystems 102 through 120). As shown in FIG. 5 a schematic drawing of the graphical user interface including functional diagnostics for metering the condition-based maintenance for a historical time in a portion of the oil and gas subsystems 102 through 120, according to some embodiments is illustrated. Display with a dropdown menu for an individual month at a time, e.g., July 2022, for the one meter segment or oil and gas subsystem 102 through 120, such as, for example, oil export skid 104 is illustrated in FIG. 5. For example, a graph 510 illustrates an automatic gain control with high and low values of the parameter as well as the high limit. A graph 520, for example, illustrates high and low values of a signal to noise ratio as well as the high limit. According to some embodiments, a graph 530 illustrates the high and low values of a performance parameter as well as the low limit. A graph 540, for example, illustrates high and low values of a phase shift as well as the low limit.

FIG. 6 is a schematic drawing of the graphical user interface including system integrity and process conditions for metering the condition-based maintenance for a historical time in a portion of the oil and gas subsystems 102 through 120, according to some embodiments. Display with a dropdown menu of an individual month at a time, e.g., July 2022, for the one meter segment or oil and gas subsystem 102 through 120, such as, for example, oil export skid 104 is illustrated in FIG. 5. For example, graph 610 illustrates calculated and measured velocity of sound (VoS) values of AGA with high and low deviation limits, according to some embodiments. A graph 620 illustrates a profile factor with high and low points as well as high and low deviation limits, according to some embodiments. A graph 630, illustrates a symmetry with high and low deviation points as well as upper and lower limits, according to some embodiments. A graph 640 illustrates turbulence with inner and outer cords as well as limits for inner and outer cords, according to some embodiments.

Utilizing the oil and gas metering system 100, a user may identify which metering devices 122 through 186 need to be inspected for calibration and identify a possible cause for malfunctioning. Reducing calibration events may provide reduced labor hours and/or a reduced number of back-up meters that are commissioned at the site. Typically, the oil and gas entity does not have access to the metering device under calibration for up to six months while the metering device is calibrated. Some regulatory authorities such as the North Sea Transition Authority issues regulations to minimize containment breaks (i.e., the entries into the integral formation of the containment). Thus, reduced number of such containment breaks may be beneficial for the oil and gas entity.

The oil and gas metering system 100 implemented according to the embodiments illustrated in FIGS. 4-6 may provide an evidence of metering accuracy during possible disputes with customers or regulatory authorities. In some embodiments, the oil and gas metering system 100 may deliver the evidence that the metering device is not drifting.

In some embodiments, the oil and gas metering system 100, may obtain, analyze, and present data available from metering devices 122 through 186. For example, in some embodiments, ultrasonic flow metering device (USM) may provide the data regarding axelpaths, the swirl, the drive gain, and other parameters of the oil and gas subsystems 102 through 120. In some embodiments, engineering computer systems may be off-shore, thus, remote monitoring at least some of the oil and gas subsystems 102 through 120 may be enabled by obtaining data from the remote computer systems utilizing the oil and gas metering system 100.

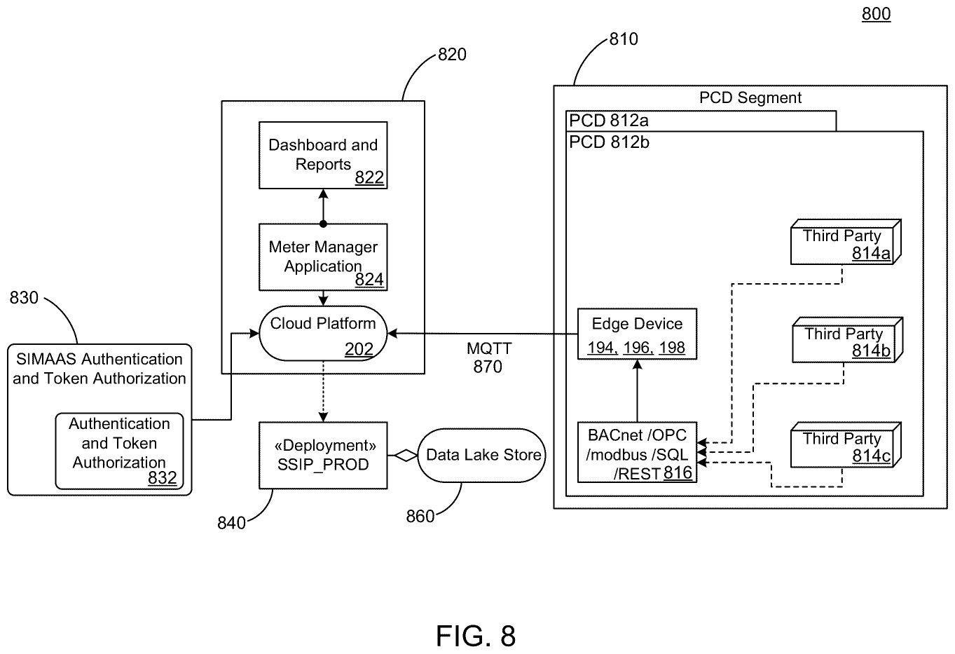

In some embodiments, the oil and gas metering system 100 may run interrogation systems, pull data from a data lake (e.g., the data lake store 860 in FIG. 8), e.g., a repository of data stored in a native format (for example, some oil and gas entities may have their own data lakes). The oil and gas metering system 100 may obtain the data and apply rule sets to optimize the operation conditions of the oil and gas subsystems 102 through 120, according to some embodiments.

In some embodiments, the oil and gas metering system 100 may establish limits for the high and low measurements and/or alarm if a reading from the metering device 122 through 186 violates the limits. As described above, for example, in graph 230, in FIGS. 2A-2B, such alarm signal may be transmitted to the user interface (UI) 204 when actual emissions exceeded the limit on July 1-July 5, July 8, and July 23-July 31, according to some embodiments.

As shown in FIGS. 7A-7B, schematic drawings of the graphical user interface including data points of metering various parameters for a historical time in a portion of the oil and gas subsystems 102 through 120, according to some embodiments are illustrated. For example, utilizing the oil and gas metering system 100 for metering data points may enable metering engineers to conduct checks of the metering devices 122 through 186 digitally and review historical data and/or trends.

According to some embodiments, display with a dropdown menu of an individual day, e.g., Jul. 1, 2022, at a time for the one of the meter segments or oil and gas subsystems 102 through 120, for example, MPM subsea system is illustrated in FIGS. 7A-7B. In some embodiments, detailed readings of the metering devices 122 through 186 are performed every 15 minutes for the required the data points. For example, the number of data points may be between 150 and 300, according to some embodiments.

For example, FIGS. 7A-7B illustrate a selection of Jul. 1, 2022, for the MPM subsea system 102. In some embodiments, a graph 710 illustrates a volume of a gas flow per each hour where the data points are taken every 15 minutes. According to some embodiments, graphs 720 and 740 illustrate pressure data taken at two metering devices per each hour where the data points are taken every 15 minutes. For example, to assess effectiveness of compressor activities, connected production compressors may be metered to identify if correlation exists between the data points from the production compressors with production flow metering devices 122 through 186. A graph 730 illustrates a mass flow per each hour where the data points are taken every 15 minutes, according to some embodiments.

In some embodiments, automated and digitized checks of the metering devices 122 through 186 may be achieved. Typically, such checks of the metering devices 122 through 186 are performed manually and on-site. In some embodiments, all or some metering readings of the parameters from the data sets 206, 208, and 210 (for example flow, temperature, pressure, etc.) can be transmitted to the cloud 202. In some embodiments, for example, the reports illustrated in FIGS. 2-7 may be exported to an Excel spreadsheet, Access and/or other data management applications.

Utilizing a configuration of the oil and gas metering system 100 having the automated and digitized checks may, for example, enable addressing proactively and autonomously adverse operating conditions. Cost of performing the metering checks is reduced when such checks are automated and/or digitized according to some embodiments. Operations involving metering checks may be transferred from in-person to a centralized and/or off-site locations according to some embodiments. Automated and/or digitized checks of the oil and gas metering system 100 may reduce critical events by identifying them earlier enough before, for example, the critical failure or another event that requires a relatively greater than normal investment of labor hours, financial expenses, and/or a negative impact to environment.

In some embodiments, the oil and gas metering system 100 may enable the parameters ingested by the metering devices 122 through 186 to be accessed and analyzed on the supervisory computer 188, 190, and 192, bridge devices 194, 196, and 198 and/or user interface (UI) 204 of the user device. In some embodiments, a speed of performing the metering check in the oil and gas metering system 100 configured to perform the automated and/or digitized checks may be faster than in typical metering check operations involving on-site inspection of the metering devices 122 through 186. In some embodiments, the metering checks may be presented to a user as configuration checks, e.g. as a master document.

In some embodiments, the followings areas can benefit from the digitized metering operations that the oil and gas metering system 100 can support: (i) enabling data and controls technology, (ii) connectivity technology, and (iii) integrated analytics. The enabling data and controls technology includes remote configuration software and metering analytics. The remote configuration software can change the meters through software applications. The metering analytics provides detailed, real-time almost continuous diagnostics of meter conditions and performance. The connectivity technology includes on-site connectivity solutions and off-site connectivity solutions. The on-site connectivity solutions can transmit data throughout the site at least partially monitored by the oil and gas metering system 100. The off-site connectivity solutions can transmit data from the site at least partially monitored by the oil and gas metering system 100 to off-sight locations; the data becomes accessible off-site. The integrated analytics includes cloud based integrated analytics that integrates meter data to make the underlying systems accessible off-sight and/or at a higher level (e.g., at a site portfolio level).

FIG. 8 is a schematic block diagram of an architecture 800 of the oil and gas metering system 100. In some embodiments, the architecture 800 can include a PCD segment 810, a manager platform 820, an authentication and/or authorization platform 830, a deployment module 840, a data lake store 860. In some embodiments, the manager platform 820 can include a cloud platform 202 (as described with reference to FIG. 1), a dashboard and reports module 822, a meter manager application 824.

In some embodiments, the PCD segment can include one or more PCDs 812a, 812b, . . . (generally denoted as 812). The PCD 812 can include an edge device 194, 196, or 198, one or more communication protocols and/or interfaces 816, and one or more third party systems 814a, 814b, 814c, . . . (generally denoted as 814). The third party systems 814 can generate or provide meter manager data (e.g., the flow rate, temperature, pressure, etc.), gas chromatography meter health data (e.g., response factors, retention times, and live or near real-time uncertainty data, etc.), other meter technology meter health data (e.g., condition based maintenance (CBM) data) (for example, ultrasonic, Coriolis, turbine and/or differential pressure, etc.). Though the third party system(s) 814 are referenced above as the systems providing or generating the metering and/or sensing data, in some embodiments, the metering and/or sensing data can be provided or generated by the systems controlled by the site operator(s) and/or the systems 102-120 included in the oil and gas metering system 100. In some embodiments, the above data may be obtained from the industry calculations rather than or in addition to being provided or generated by the third party system(s) 814 and/or the metering systems 102 through 120.

In some embodiments, the communication protocols and/or interfaces 816 can include a communication protocol to connect building automation and control systems (BACnet), open platform communications (OPC) protocol for industrial automation applications, Modicon bus (Modbus) protocol for industrial control systems, structured query language (SQL), representational state transfer (REST), and the like communication protocols and interfaces that facilitated transmission of the data from the third party systems 814a, 814b, or 814c to the edge device 194, 196, or 198. The edge device can transmit the data generated or provided by the third party systems 814 to the cloud platform 202 via a Message Queuing Telemetry Transport (MQTT) protocol 870. The meter manager application 824 con control an operation of the manager platform 820. For example, the meter manager application 824 can send the commands or instructions to the cloud platform 202 and the dashboard and reporting module 822.

The authentication and/or authorization platform 830 can be provided by a security information management as a service (SIMAAS) provider that can deliver security information and event management (SIEM) capabilities to the oil and gas metering system 100. The authentication and/or authorization platform 830 can authorize tokens. The authentication and/or authorization platform 830 includes an authentication and token authorization module 832 for managing the security of the oil and gas metering system 100. The deployment module 840 can be electrically coupled with the data lake store 860. In some embodiments, the data lake store 860 can be a cloud-based data storage service. The deployment module 840 can receive the commands or instructions from the cloud platform 202 to provide the user, via the UI 204 (FIG. 1), the enabling data and controls technology, connectivity technology, and/or integrated analytics.

A reference is now made to the UI wireframes of the oil and gas metering system 100. In some embodiments, the following functionalities can be provided by the UI 204: trending data, data tables and/or exporting capabilities, fault detection and diagnostics that can have a prioritization, hierarchy, role based access, equipment metadata, and/or alerts. In some embodiments, the trending data can include: (i) a real-time or near real-time almost continuous plotting of data points on a graph to provide a visual context reflecting a change the data points over time; (ii) various time frames: e.g., hourly, daily, week, month, year-to-date (YTD) and a year; (iii) aggregate and/or average time periods greater than a week; (iv) setting and monitoring thresholds for the data points that have ideal ranges.

In some embodiments, the UI 204 that provides or generates the data tables exporting can include presentation of all data points and evaluations to the user, such that the data can be filterable and exportable to, e.g., a csv format for an ad-hoc analysis.

In some embodiments, the UI 204 that provides or generates the data for the fault detection and/or diagnostics having a prioritization can include the following outputs. For example, pre-determined, rules-based approach can identify specific conditions and based on meeting such conditions, the oil and gas metering system 100 can trigger a “fault” signal and list it in the fault module of the oil and gas metering system 100.

In some embodiments, the faults can be based on logic depending on a single variable, e.g., if the value of an automatic gain control is above 55, then the oil and gas metering system 100 triggers a fault. In some embodiments, the fault can be complex algebraic formula with multiple variables. Faults can be added by users but can align on standards that desirable for deployment at the oil and gas site. Typically, a monetization factor is used for prioritization. In some embodiments, prioritization assignment can be performed for metering (e.g., critical and non-critical metering).

In some embodiments, the hierarchy functionality of the UI wireframes can include a view of the data by the user at portfolio and/or asset levels. In some embodiments, the role based access functionality of the UI wireframes can limit the view of the data by the user to portfolio and/or specific assets based on the user's role. In some embodiments, the equipment metadata functionality of the UI wireframes can assign attributes to equipment such as technology (USM, Turbine), OEM, and a model number. In some embodiments, the functionality of the UI wireframes related to alerts can provide notifications outside of the oil and gas metering system 100 (e.g., via email, text, and the like) when, for example, critical events occur.

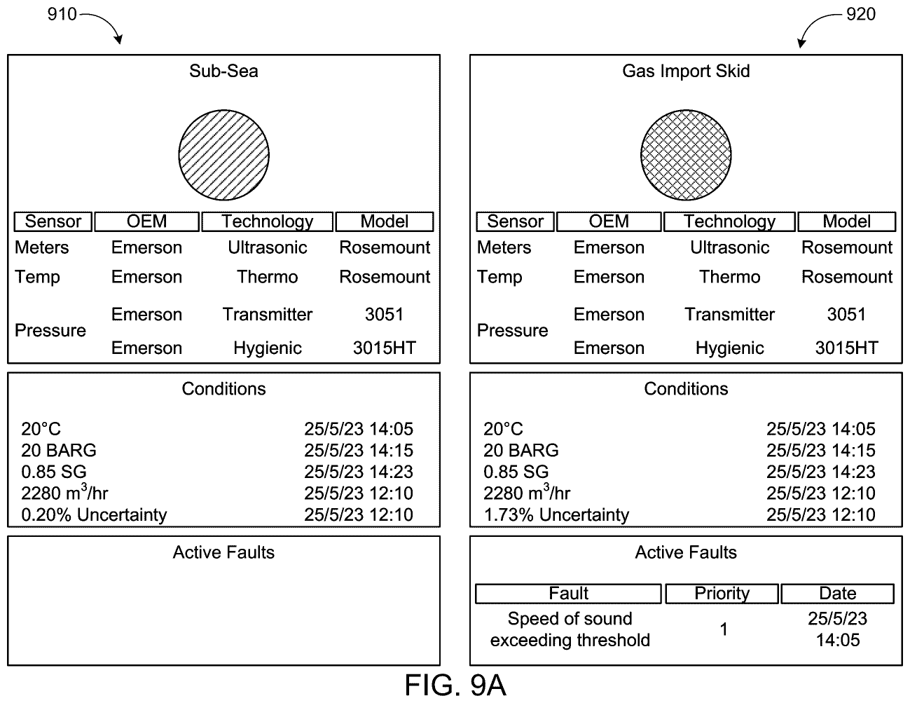

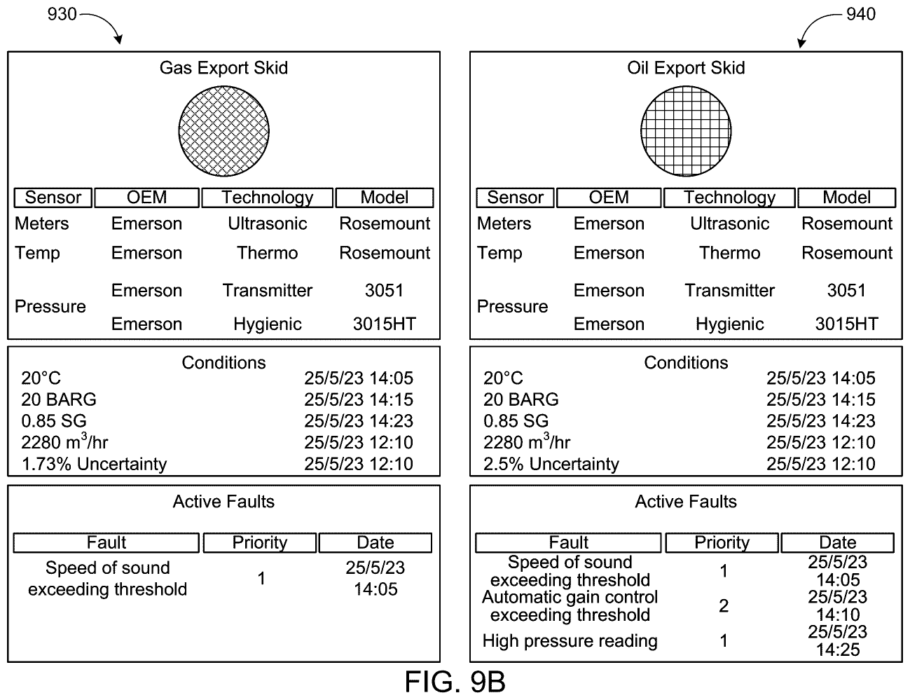

In some embodiments, the UI wireframes can include the following types of summaries: a meter summary, a process metric summary, condition based maintenance analytics, flare monitoring, and/or data dump report. For example, the meter summary can provide a relatively quick overview of meter health status, operational issues and summary of issues for metering technicians and management. For example, FIGS. 9A-9B illustrate a meter health summary in the UI wireframes for the sub-sea system 102, the gas import skid 108, the gas export skid 106, and the oil export skid 104. For example, the meter health summary 910 for the sub-sea system 102 illustrates that there are no active faults, and the color of a status for the sub-sea system 102 can be, for example, green. For example, the meter health summaries 920 and 930 for the gas import skid 108 and the gas export skid 106, respectively, illustrate that there is one active fault for each summary 920 and 930 (e.g., a speed of sound exceeding the threshold). In some embodiments, the color of a status for the gas import skid 108 and the gas export skid 106 can be, for example, yellow. For example, the meter health summary 940 for the oil export skid 104 illustrates that there are three active faults (e.g., a speed of sound exceeding the threshold, the automatic gain control exceeding the threshold, and the high pressure reading). The color of a status for the oil export skid 104 can be, for example, red.

In some embodiments, the process metric summary can include a single page, a scrollable report including the process metrics for a specific metering segment or the metering systems 102-120. The metering technicians and management personnel can use the process metric summaries, for example, to obtain high overview of the statuses for the metering systems 102-120 and their general process conditions. The process metric summaries can facilitate the metering technicians and management personnel in their decision making process to preliminarily assess issues and/or faults to determine urgency and the type of mitigation required in a particular case.

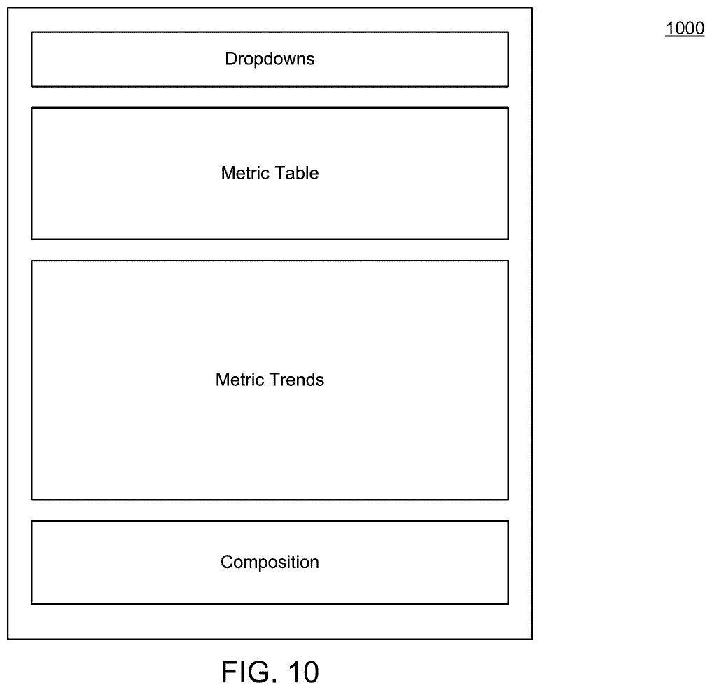

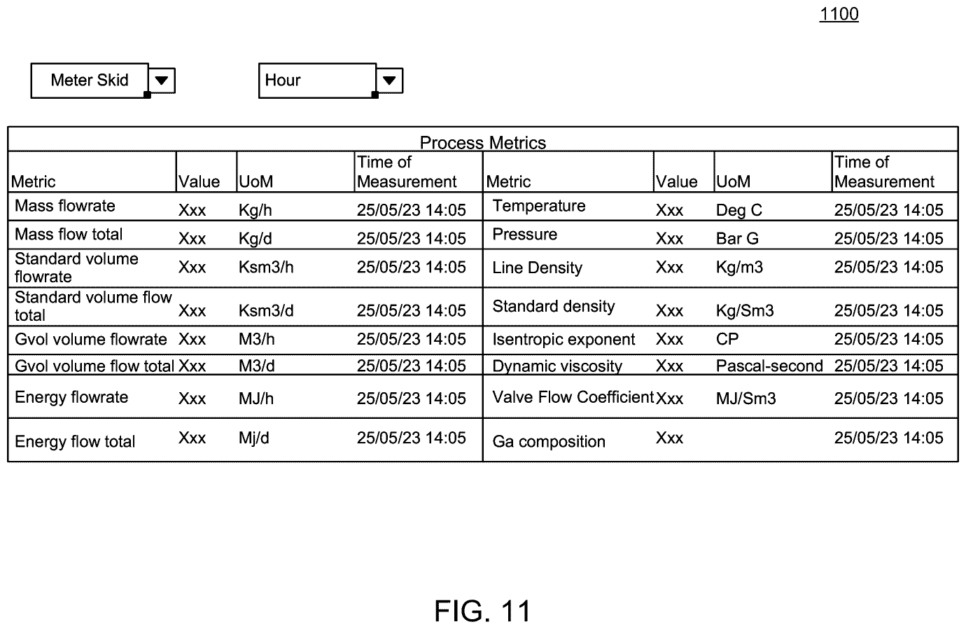

FIG. 10 illustrates a structure 1000 of the UI wireframe for the process metric summary, according to some embodiments. For example, the structure 1000 of the UI wireframe can include a dropdown menu, a metric table menu, a metric trends menu, and a composition menu. FIG. 11 illustrates a metric data table 1100 of the UI wireframe for the process metric summary, according to some embodiments. For example, the user can choose the meter skid and an hour in the menus of the structure 1000 in FIG. 10.

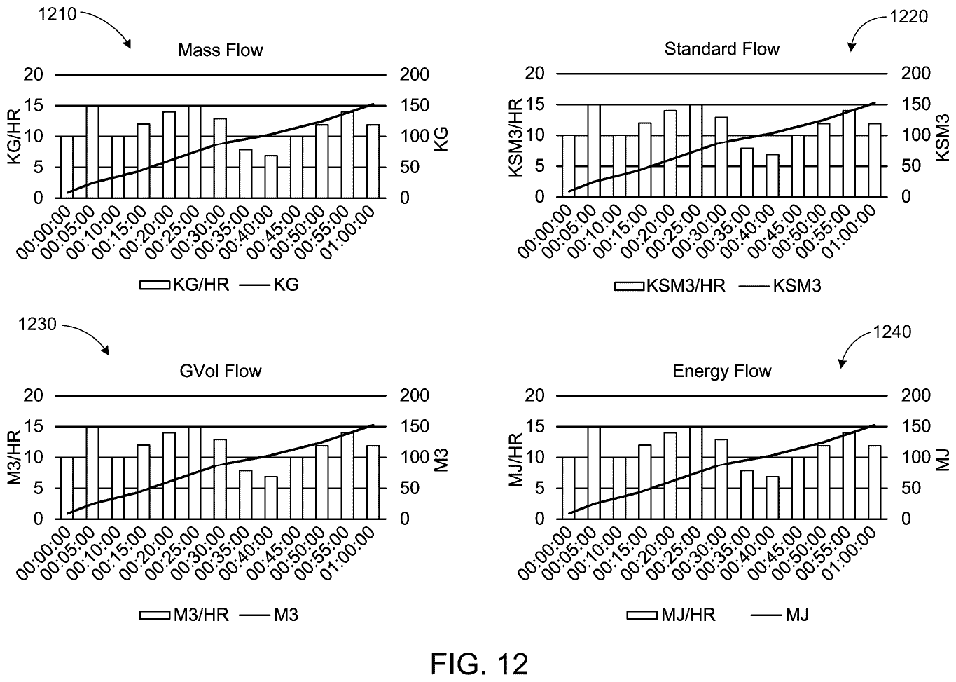

FIGS. 12-14 illustrate the metric trends in the UI wireframe for the process metric summary, according to some embodiments. For example, trend lines can be used for a period of time lasting one day or less. A box plot (or a box and whiskers) can be aggregated for a variable measured for period of time that is greater than one day and shorter than one month. A boxplot can be aggregated for a variable measured for period of time that is greater than one month and shorter than one year. In some embodiments, a one year period can be a maximum period for the time filterable in the time selection. The time can be measured in hours, days, weeks, months, years, or being YTD. In some embodiments, a trend graph can have thresholds that align with fault rules. In some embodiments, the fault rules can be configurable by the user.

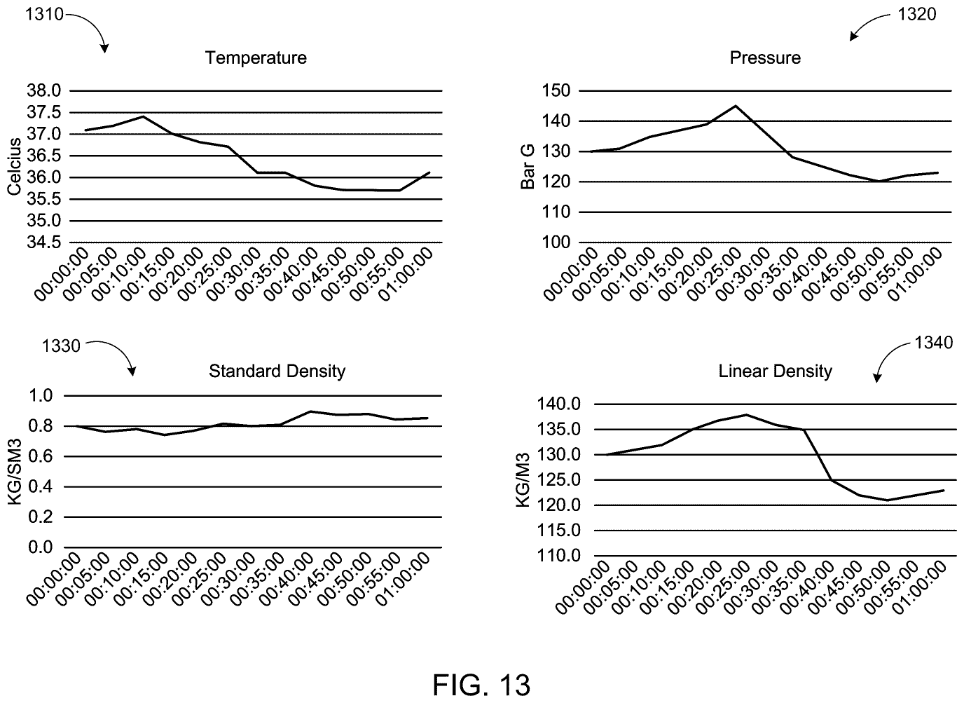

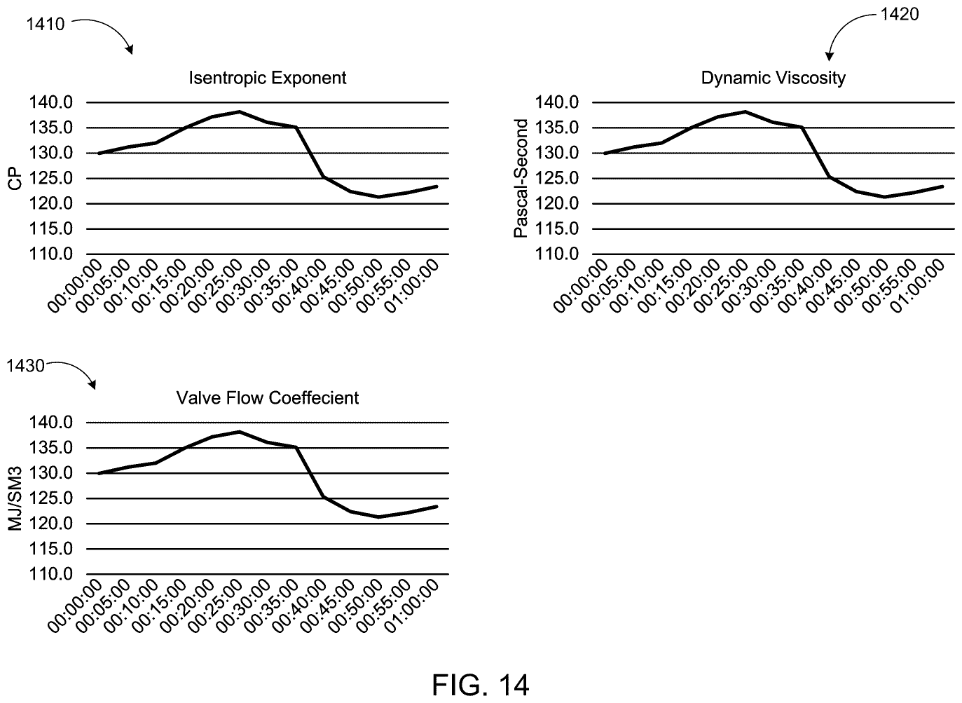

For example, FIG. 12 illustrates a trend 1210 of a mass flow metric, a trend 1220 of a standard flow metric, a trend 1230 of a GVol flow metric, and a trend 1240 of an energy flow metric. For example, FIG. 13 illustrates a trend 1310 of a temperature metric, a trend 1320 of a pressure metric, a trend 1330 of a standard density metric, and a trend 1340 of a linear density metric. For example, FIG. 14 illustrates a trend 1410 of a an isentropic exponent metric, a trend 1420 of a dynamic viscosity metric, and a trend 1430 of a valve flow coefficient metric.

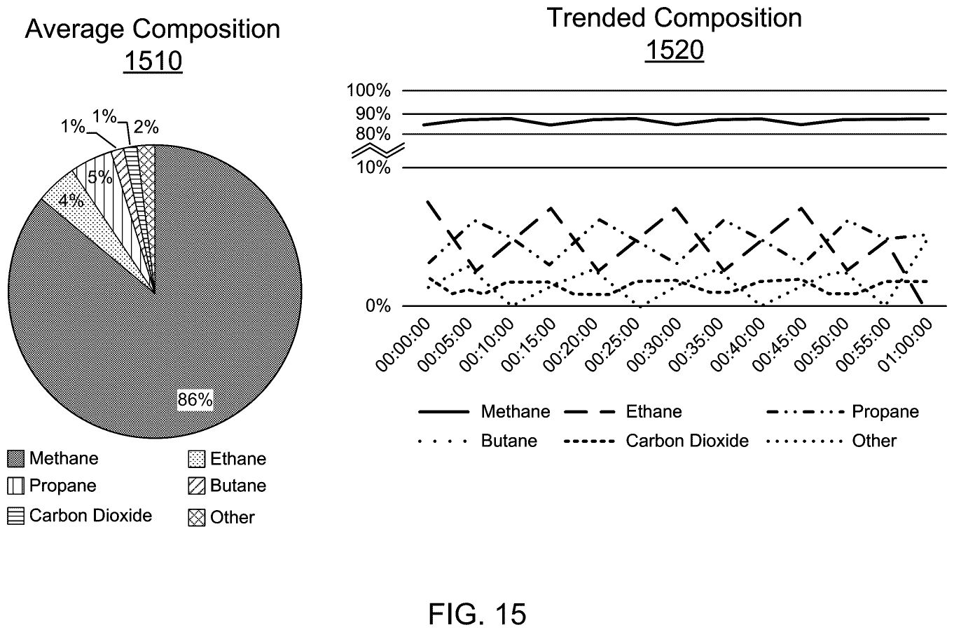

FIG. 15 illustrates the composition in the UI wireframe for the process metric summary, according to some embodiments. For example, an average composition 1510 can illustrate the content of the methane, ethane, propane, butane, carbon dioxide, and other chemical compounds averaged for a period of time. In some embodiments, a trended composition 1520 can illustrate the trends of the above chemical compounds depending on the time when the composition is measured.

In some embodiments, the UI wireframes having condition based maintenance (CBM) analytics provide details of the equipment that does not function properly when faults and/or issues were identified. A user working with the CBM analytics is expected to have knowledge of a course of action if a specific metric has violated its threshold. For example, a compliance summary of metrics can show all faults that occurred with respect to a specific meter during the selected time period. A fault severity prioritization can be incorporated in the UI wireframes. A calendar and line graphs can follow similar formats described above with respect to, e.g., FIGS. 12-14. The following diagnostic data can be used with respect to a metering type that include the trend graphs. For example, a technology utilizing ultrasonic condition based maintenance analytics can have the following metrics: an automatic gain control, a signal to noise ratio, a measurement performance, a phase shift, a calculated velocity of sound (VoS), a measured VoS, a profile factor, a symmetry, a turbulence, a swirl ratio, a flatness ratio, and/or differences between calculated measurements and standard values. For example, a technology utilizing gas chromatograph condition based maintenance analytics can have the following metrics: response factors, retention times, unnormalized total values, and/or chromatograms. For example, a technology utilizing Coriolis condition based maintenance analytics can have the following metrics: a drive gain, a signal amplitude, a tube frequency, a flow tube health check, a measured density, a meter temperature, a measured flow rate, a meter zero, and/or differences between calculated measurements and standard values. For example, a technology utilizing differential pressure condition based maintenance analytics can have the following metrics: a pressure, differences between calculated measurements and standard values, and/or metrics. For example, a technology utilizing turbine may use different metrics. In some embodiments, when the difference between the desired output (e.g., the standard value or the norm value) and the measured data is equal or exceeds three standard deviations, the alert, a visual representation indication anomalous operation of the monitored component of the oil and gas metering system 100 can be initiated to notify a user about such deviation between the desired and the measured outputs.

In some embodiments, various technologies can utilize uncertainty metric. For example, the root cause of uncertainty may be identified utilizing the oil and gas metering system 100. The oil and gas metering system 100 can be utilized to find and manage uncertainty. For example, the oil and gas metering system 100 can provide analytical and empirical techniques to identify a root cause of the uncertainty in estimated parameter values of the metering subsystems 102-120. Analytical techniques can involve calculating the covariance matrix of model parameters based on the gradient of the model output. The diagonal entries of the covariance matrix allow numerical quantification of the uncertainties in each parameter estimate. Empirical techniques like bootstrap and jackknife resampling generate multiple parameter estimates over different data samples to characterize the distribution and uncertainty.

Larger uncertainties in the estimated values of parameters lead to reduced certainty and precision in predictions of the oil and gas metering system 100. More accurate quantification of the parameter uncertainties thereby allows the confidence intervals around the forecasts provided by the oil and gas metering system 100 to be properly characterized. Finding the root cause of the uncertainties in parameters like the temperature, pressure, density, velocity, and the like further enables improving the accuracy of applications that rely on the analytical model of the oil and gas metering system 100. The applications may include performance analysis to baseline automated fault detection to identify equipment in need of repair and identification of potential opportunities (e.g., reducing emissions approaching an allowable limit) through upgrades or improved operational practices. The quantification of parameter uncertainty facilitates accounting for model inaccuracies in such analytics and improves the actionability of the results.

Additionally, the analytical techniques for uncertainty quantification enable advanced multivariate analysis of the correlations between different model parameters. By determining parameter uncertainties simultaneously rather than individually, insights may be gained into the interdependencies and relationships between parameters through visualizations of the multivariate uncertainty. Such multivariate analysis provides key insights into the building energy model that can be achieved without joint quantification of the parameter uncertainties.

In some embodiments, the oil and gas metering system 100 can collect and process large amounts of data from various sources. By analyzing this data using advanced analytics tools and techniques, patterns and trends can be identified, providing valuable insights into potential uncertainties. In some embodiments, machine learning algorithms can identify complex patterns and relationships within data, enabling better predictions and reducing uncertainty. For example, AI systems can process and analyze data at higher scales and speeds than typical computing systems not equipped with AI. Advanced simulation and modeling techniques can be used to create virtual representations of complex systems. By running simulations under different scenarios, the impact of various factors on outcomes can be assessed, helping to manage uncertainties. The IoT devices (such as the edge devices 194, 196, or 198) can provide real-time or near real-time data from various sources, such as sensors and connected devices. This data can be leveraged to monitor and manage uncertainties at the oil and gas site. Utilizing historical data and machine learning algorithms, predictive analytics of the oil and gas metering system 100 can forecast future events and outcomes, providing valuable insights to mitigate uncertainties. Cloud computing of the oil and gas metering system 100 offers scalable and cost-effective solutions for processing and storing large datasets, facilitating a more efficient access to powerful analytical tools without expensive investments in infrastructure. The oil and gas metering system 100 can include software applications designed for risk management that can assist in identifying potential uncertainties, assessing their impact, and developing appropriate mitigation strategies. Advanced monitoring of the oil and gas metering system 100 can provide real-time data and alerts, enabling relatively rapid responses to emerging uncertainties and potential risks.

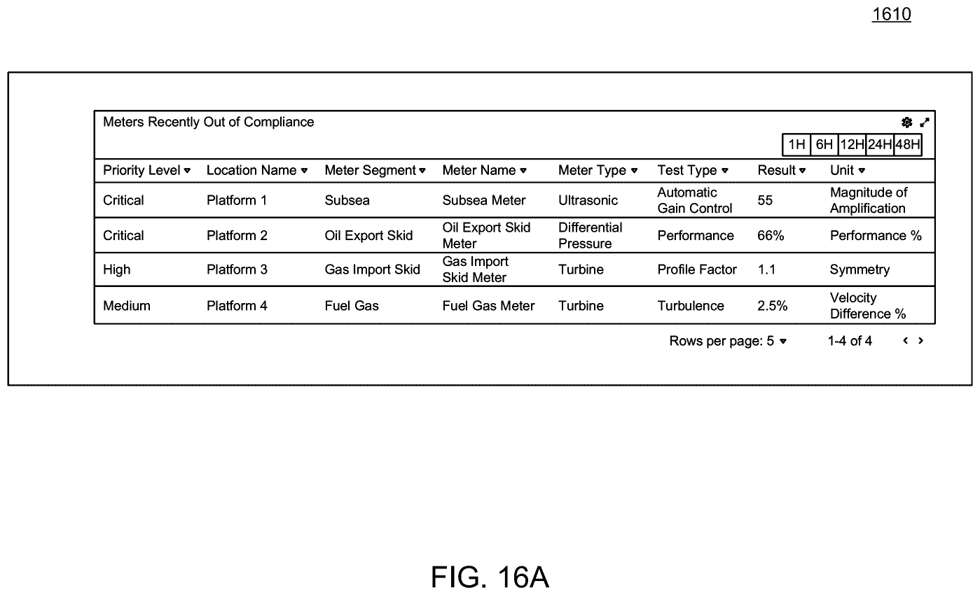

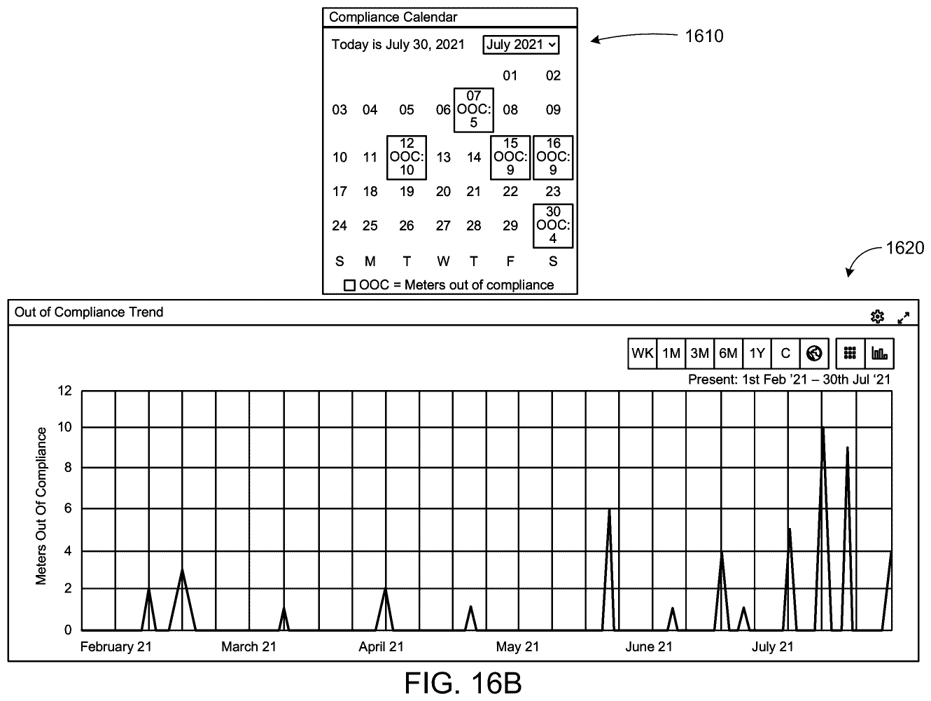

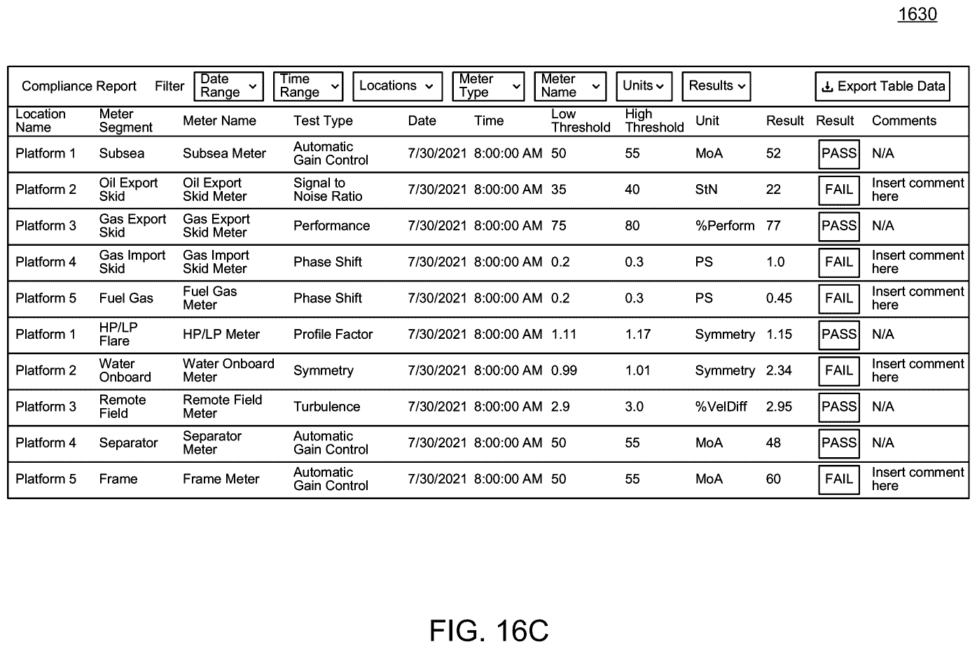

FIGS. 16A-20 illustrate the UI wireframes providing various monitoring of the oil and gas metering system 100. For example, FIGS. 16A-16C illustrate the compliance or non-compliance of components of the meter segments 102-120 monitored by the oil and gas metering system 100. For example, a wireframe 1600 in FIG. 16A illustrates meters that were out of compliance recently. For example, a wireframes 1610 and 1620 in FIG. 16B illustrate a compliance calendar (showing, e.g., the meters that were out of compliance on specific dates) and an out of compliance trend, respectively. For example, a wireframe 1630 in FIG. 16C illustrates an overall compliance report available for export and filtrable according to user preferences.

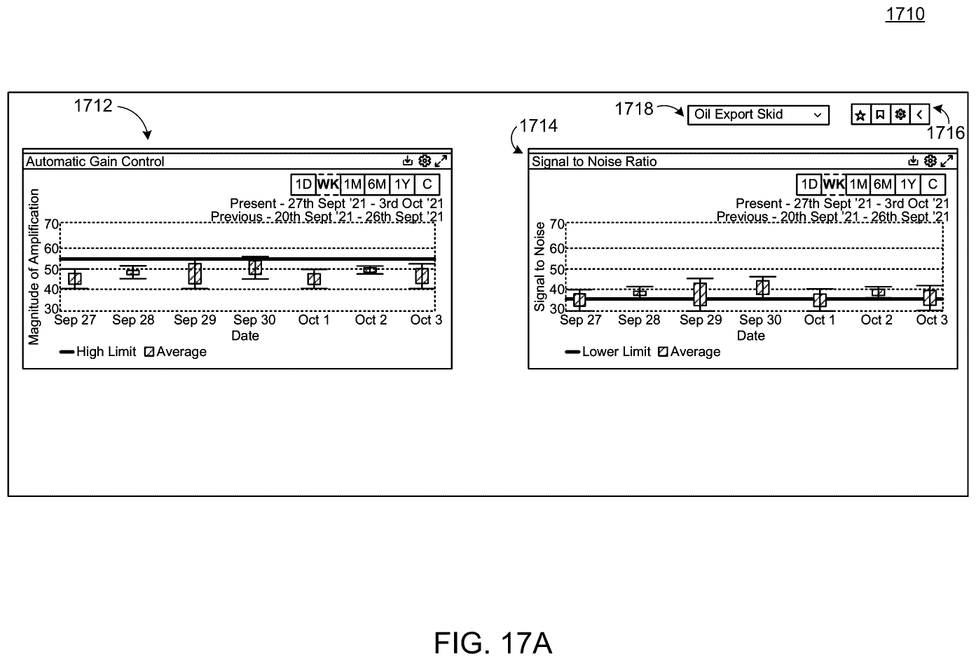

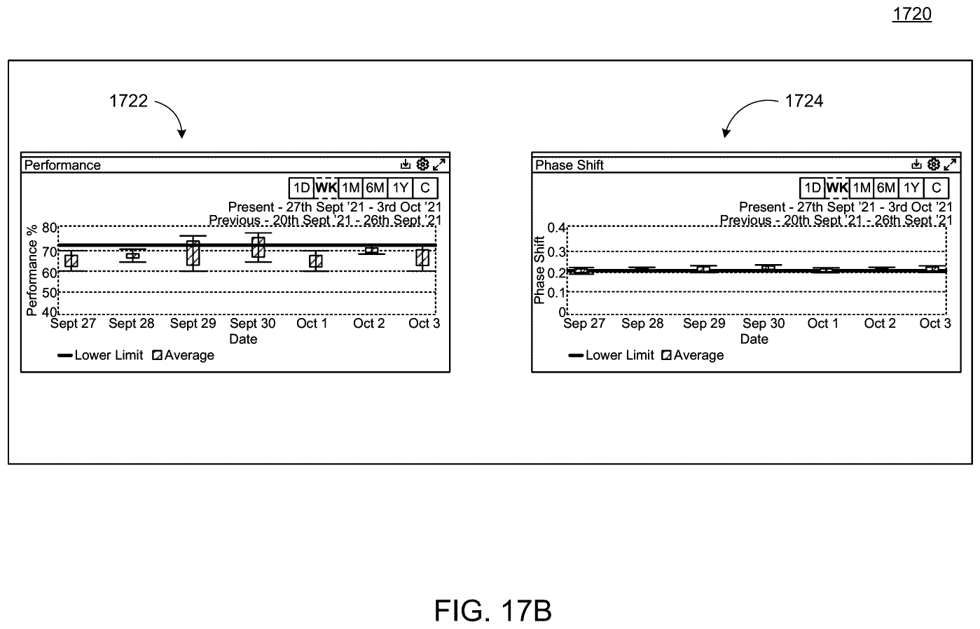

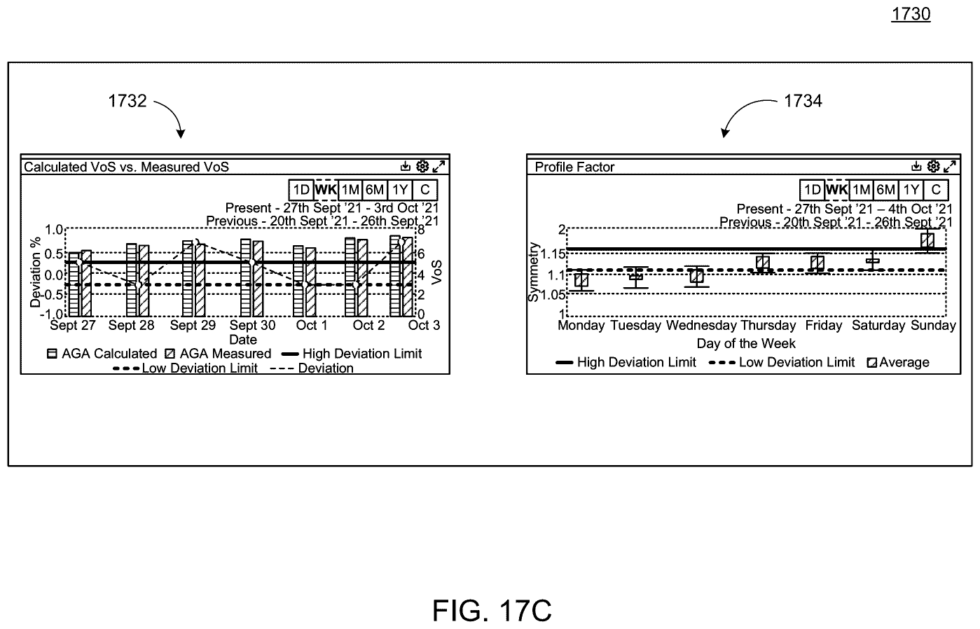

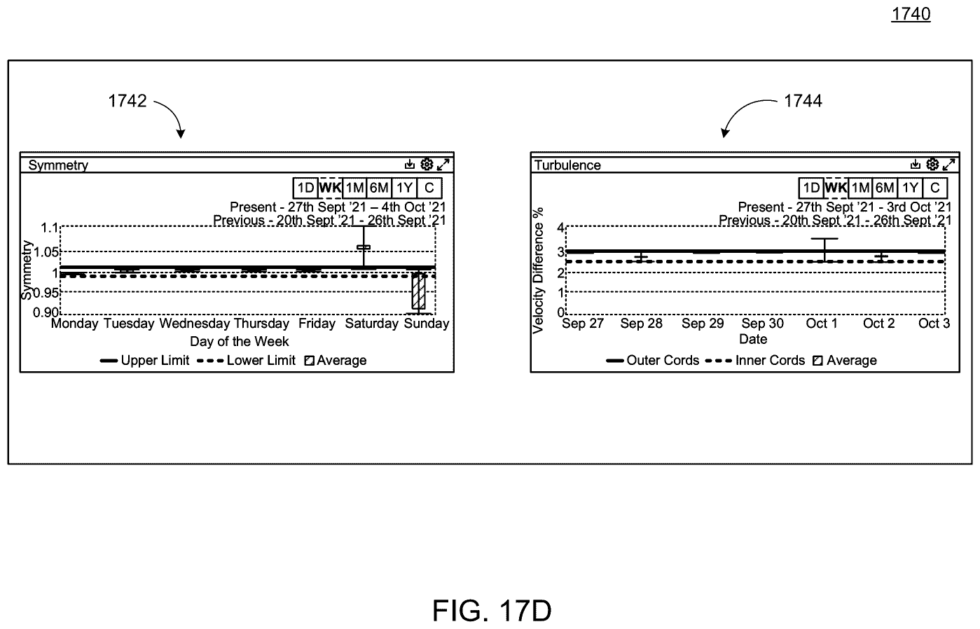

FIGS. 17A-17D illustrate UI wireframes showing the boxplots for the data received from components of the meter segments 102-120 monitored by the oil and gas metering system 100. For example, a UI wireframe 1710 in FIG. 17A illustrates a drop down menu 1718 a particular system 102-120 that the user selects to view. The UI wireframe 1710 includes other settings generally denoted as 1716. The UI wireframe 1710 can include a view 1712 of boxplots for the automatic gain control. The UI wireframe 1710 can include a view 1714 of boxplots for the signal to noise ratio. In some embodiments, a UI wireframe 1720 in FIG. 17B illustrates a view 1722 of boxplots for a performance and a view 1724 of boxplots for a phase shift. In some embodiments, a UI wireframe 1730 in FIG. 17C illustrates a view 1732 of deviation percentage for a calculated VoS from the measured VoS and a view 1734 of boxplots for a profile factor. In some embodiments, a UI wireframe 1740 in FIG. 17D illustrates a view 1742 of boxplots for a symmetry and a view 1744 of boxplots for a turbulence.

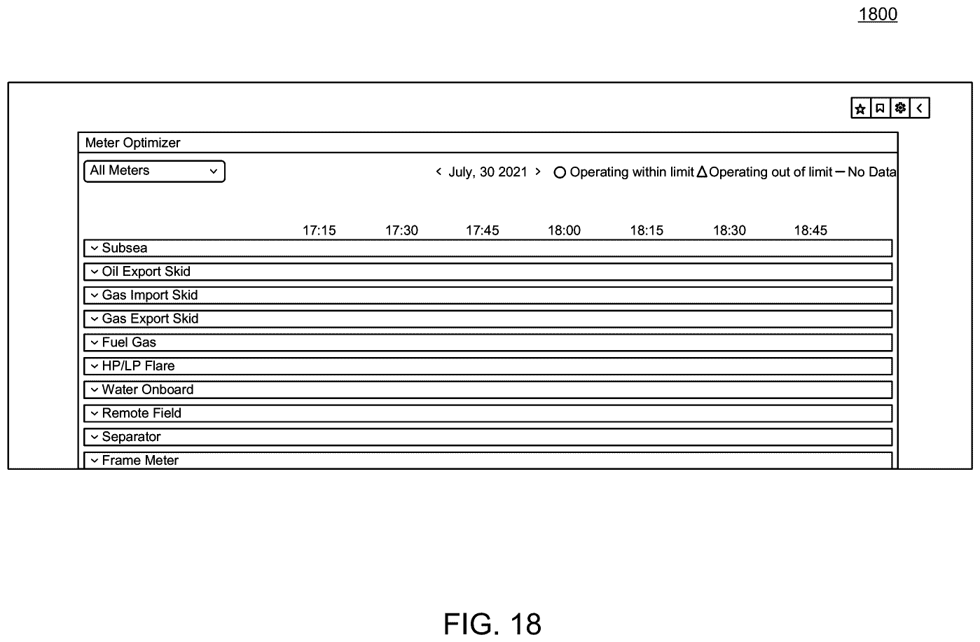

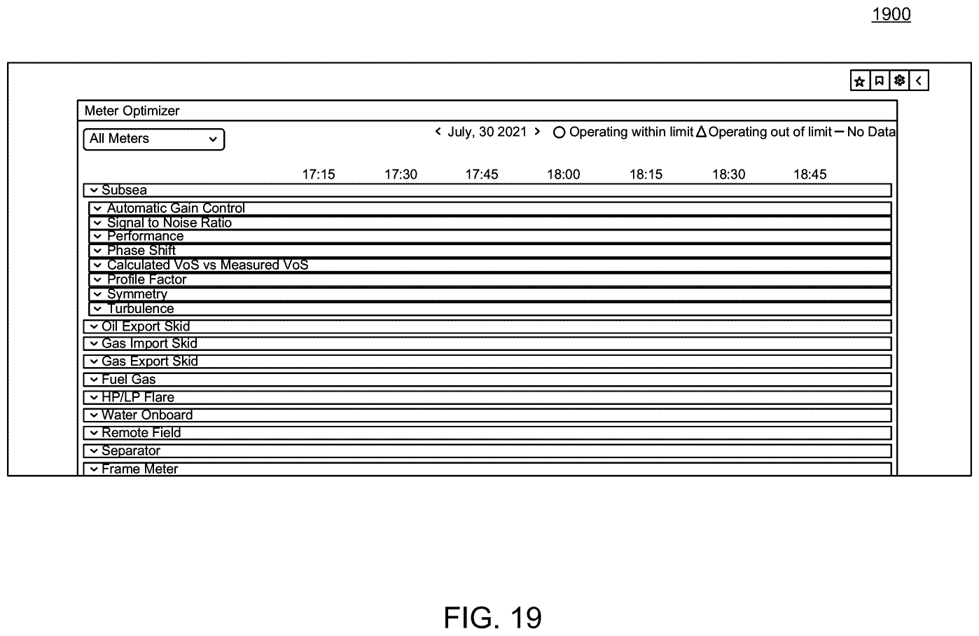

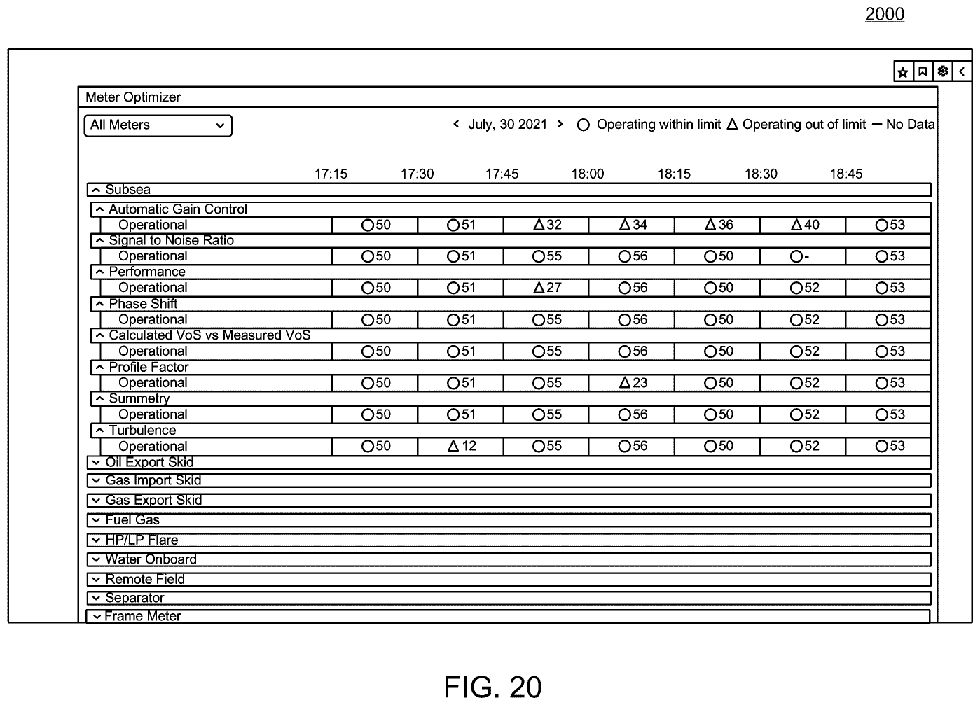

FIGS. 18-20 illustrate UI wireframes showing a meter optimizer according to some embodiments. For example, a UI wireframes 1800 in FIG. 18 illustrate a general graphical user interface (GUI) view of all meters for all segments or systems 102-120 before a selection of the segment is made by the user. A UI wireframe 1900 in FIG. 19 illustrates a GUI view when the user selected the subsea segment 102 but before the user made a selection of the parameters of the system 102. A UI wireframe 2000 in FIG. 20 illustrates a GUI view when the user selected the subsea segment 102 and the user made the selection of the metrics of the system 102. For example, the UI wireframe 2000 illustrates the metrics that operate within the limit, out of limit, or for which metrics the data is not available.

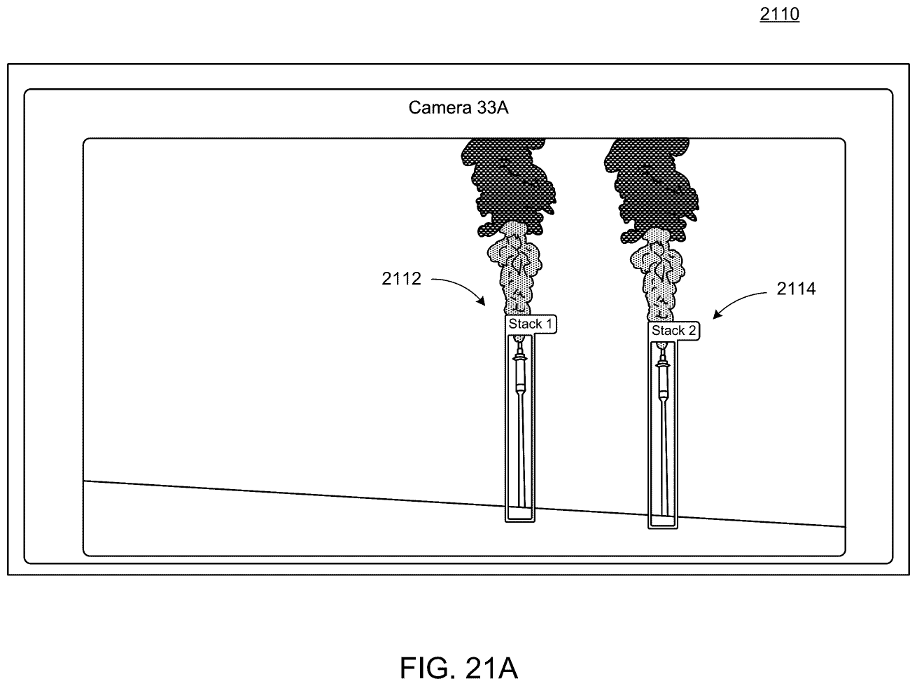

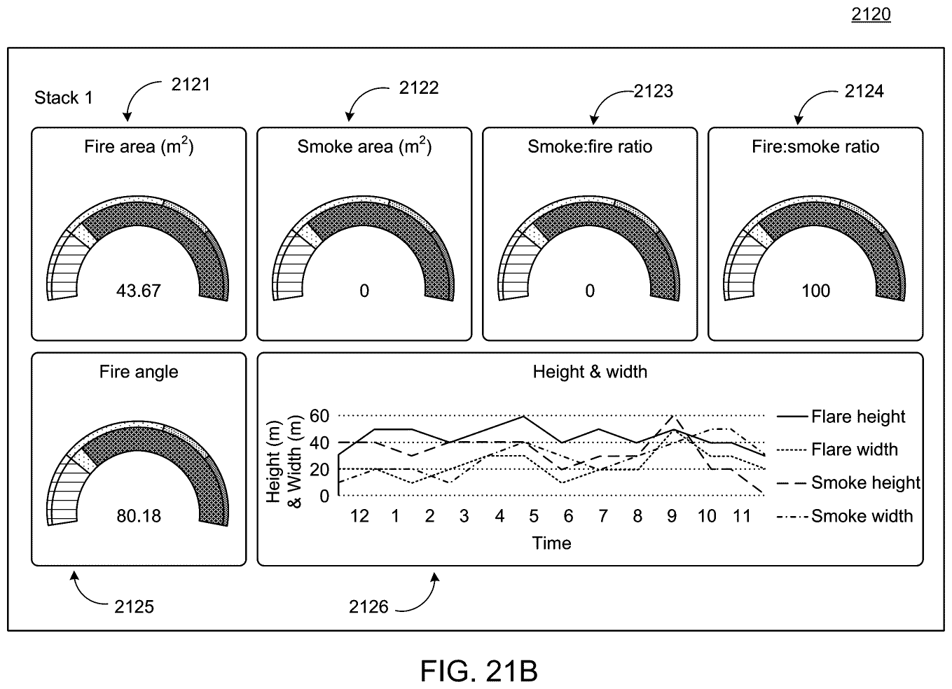

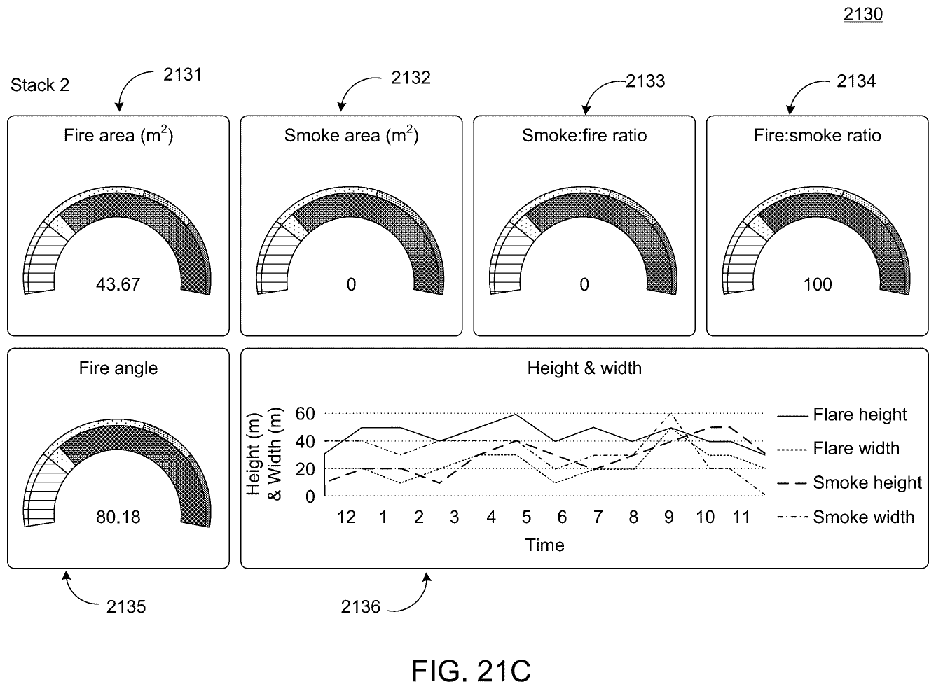

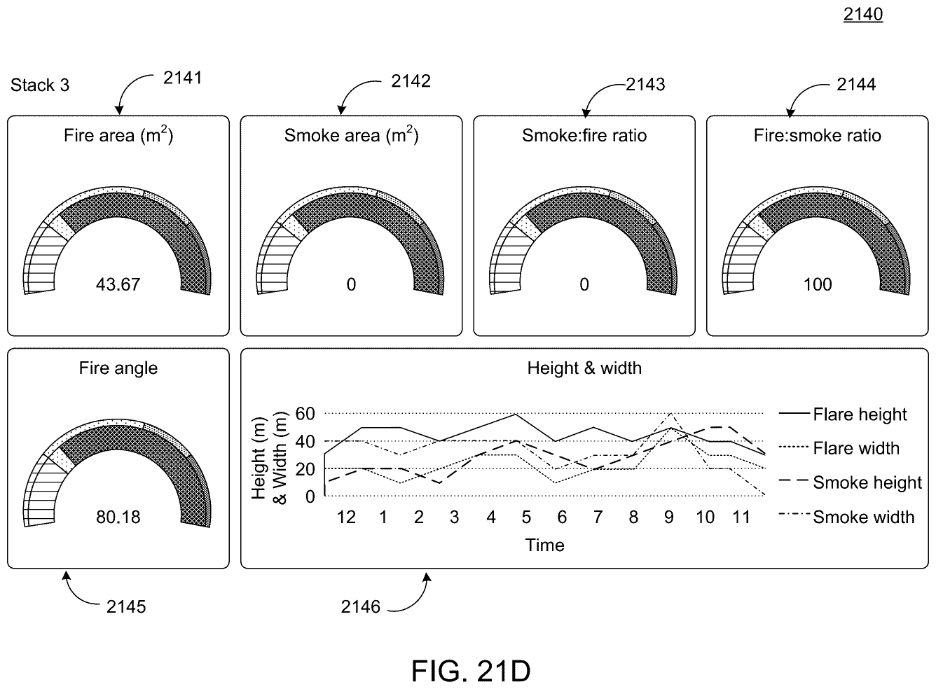

FIGS. 21A-21D illustrate UI wireframes for flare monitoring, according to some embodiments. The flare monitoring can provide details regarding a current status and history of flaring. For example, a UI wireframe 2110 in FIG. 21A illustrates a camera view of two stacks 2112 and 2114. A UI wireframe 2120 in FIG. 21B illustrates status of flare metrics for stack 1: a fire area 2121, a smoke area 2122, a smoke/fire ratio 2123, a fire/smoke ratio 2124, a fire angle 2125, and a historic view 2126 for a flare height and width, as well as a smoke height and width.

In some embodiments, a UI wireframe 2130 in FIG. 21C illustrates status of flare metrics for stack 2: a fire area 2131, a smoke area 2132, a smoke/fire ratio 2133, a fire/smoke ratio 2134, a fire angle 2135, and a historic view 2136 for a flare height and width, as well as a smoke height and width. In some embodiments, a UI wireframe 2140 in FIG. 21D illustrates status of flare metrics for stack 3: a fire area 2141, a smoke area 2142, a smoke/fire ratio 2143, a fire/smoke ratio 2144, a fire angle 2145, and a historic view 2146 for a flare height and width, as well as a smoke height and width.

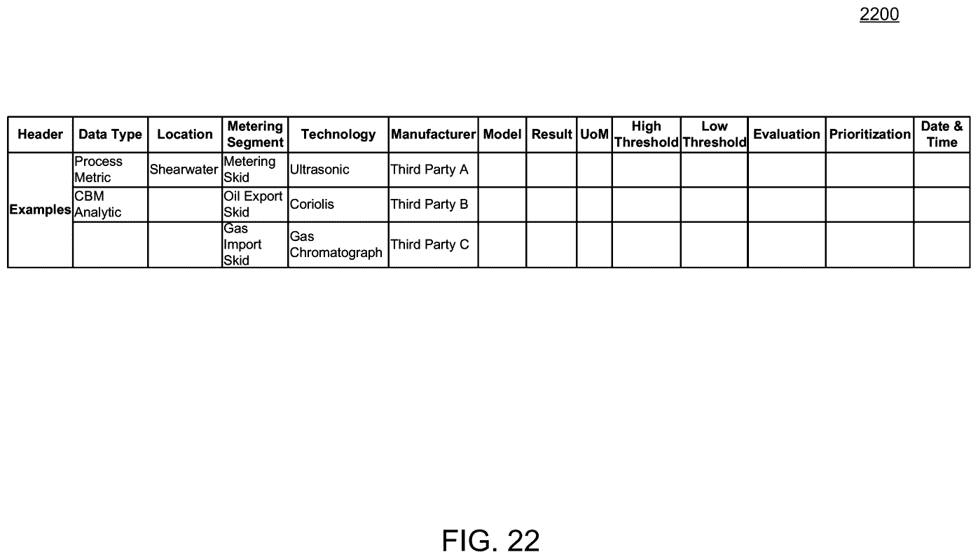

In some embodiments, a data dump report can support an ad-hoc data requests. FIG. 22 illustrates a UI wireframe 2200 that represents a data dump table that is exportable and where at least some headers are filterable. When the data is stored, for example, every five minutes, a Uniform Storage Medium (USM) may have around three million lines of data entries within one year.

Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular oil and gas subsystem or portion of an oil and gas subsystem. Computation and ingesting data as well as running AI at the edge devices provides a reduced latency as well as the reduced cloud requirements due to the reduced data traffic. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. An oil and gas metering system comprising:
an edge platform comprising at least one of a supervisory computer or a peripheral device, the supervisory computer or the peripheral device comprising one or more memory devices storing instructions thereon that, when executed by one or more processors, cause the one or more processors to:
receive historical data values from an oil and gas metering subsystem, the historical data values comprising values of a plurality of data points for a plurality of historical times;
evaluate the historical data values by at least one of the supervisory computer or the peripheral device to generate evaluation results;
generate user interface data comprising at least one of the historical data values or the evaluation results; and
transmit the user interface data; and
a cloud platform configured to receive the user interface data from the edge platform and provide the user interface data to a user device, the user interface data causing the user device to display a graphic representation of the oil and gas metering subsystem.

2. The oil and gas metering system of claim 1, wherein evaluating the historical data values comprises:
generating a plurality of different operating scenarios for operating equipment of the oil and gas subsystem for the plurality of historical times; and
simulating a plurality of values of data points of the oil and gas subsystem for the plurality of historical times based on the plurality of different operating scenarios and the historical data values.

3. The oil and gas metering system of claim 1, wherein evaluating the historical data values comprises:
generating a plurality of performance scores for a plurality of different operating scenarios based on at least one of the historical data values of the plurality of data points or the evaluation results; and
determining a future recommendation for the oil and gas metering subsystem based on the plurality of performance scores for the plurality of different operating scenarios.

4. The oil and gas metering system of claim 3, wherein the plurality of different operating scenarios include at least one of different control algorithms for the oil and gas metering subsystem, different control schedules for the oil and gas metering subsystem, installation of new equipment in the oil and gas metering subsystem, or maintenance of equipment for the oil and gas metering subsystem.

5. The oil and gas metering system of claim 1, wherein evaluating the historical data values comprises comparing a measured output of the historical data values with a desired output;
wherein generating the user interface data comprises issuing a notification in response to the measured output being at least three standard deviations from the desired output.

6. The oil and gas metering system of claim 1, wherein evaluating the historical data values comprises:
determining an uncertainty in an evaluation result of the evaluation results;
identifying a plurality of data values of the historical data values that contribute to the evaluation result; and
using an artificial intelligence model to determine which of the plurality of data values contributes most significantly to the uncertainty.

7. The oil and gas metering system of claim 1, wherein evaluating the historical data values comprises generating a recommendation based on the evaluation results, wherein the recommendation comprises at least one of a recommendation to purchase and install a new control algorithm or a recommendation to purchase and install new equipment.

8. The oil and gas metering system of claim 1, wherein evaluating the historical data values comprises generating a recommendation based on the evaluation results, wherein the recommendation comprises a recommendation to reduce production activities in response to a level of emissions exceeding an allowable limit.

9. A method comprising:
receiving, by an edge platform, the edge platform comprising at least one of a supervisory computer or a peripheral device, historical data values from an oil and gas metering subsystem, the historical data values comprising values of a plurality of data points for a plurality of historical times;
evaluating, by the edge platform, the historical data values by at least one of the supervisory computer or the peripheral device to generate evaluation results;
generating, by the edge platform, user interface data comprising at least one of the historical data values or the evaluation results;
transmitting, by the edge platform, the user interface data; and
receiving, by a cloud platform, the user interface data from the edge platform and provide the user interface data to a user device, the user interface data causing the user device to display a graphic representation of the oil and gas metering subsystem.

10. The method of claim 9, wherein evaluating the historical data values comprises:
generating a plurality of different operating scenarios for operating equipment of the oil and gas subsystem for the plurality of historical times; and
simulating a plurality of values of data points of the oil and gas subsystem for the plurality of historical times based on the plurality of different operating scenarios and the historical data values.

11. The method of claim 9, wherein evaluating the historical data values comprises:
generating a plurality of performance scores for a plurality of different operating scenarios based on at least one of the historical data values of the plurality of data points or the evaluation results; and
determining a future recommendation for the oil and gas metering subsystem based on the plurality of performance scores for the plurality of different operating scenarios.

12. The method of claim 11, wherein the plurality of different operating scenarios include at least one of different control algorithms for the oil and gas metering subsystem, different control schedules for the oil and gas metering subsystem, installation of new equipment in the oil and gas metering subsystem, or maintenance of equipment for the oil and gas metering subsystem.

13. The method of claim 9, wherein evaluating the historical data values comprises comparing a measured output of the historical data values with a desired output;
wherein generating the user interface data comprises issuing a notification in response to the measured output being at least three standard deviations from the desired output.

14. The method of claim 9, wherein evaluating the historical data values comprises:
determining an uncertainty in an evaluation result of the evaluation results;
identifying a plurality of data values of the historical data values that contribute to the evaluation result; and
using an artificial intelligence model to determine which of the plurality of data values contributes most significantly to the uncertainty.

15. The method of claim 9, wherein evaluating the historical data values comprises generating a recommendation based on the evaluation results, wherein the recommendation comprises at least one of a recommendation to purchase and install a new control algorithm or a recommendation to purchase and install new equipment.

16. The method of claim 9, wherein evaluating the historical data values comprises generating a recommendation based on the evaluation results, wherein the recommendation comprises a recommendation to reduce production activities in response to a level of emissions exceeding an allowable limit.

17. One or more non-transitory computer readable media containing program instructions that, when executed by one or more processors, cause the one or more processors to perform operations comprising:
receiving, by an edge platform, the edge platform comprising at least one of a supervisory computer or a peripheral device, historical data values from an oil and gas metering subsystem, the historical data values comprising values of a plurality of data points for a plurality of historical times;
evaluating, by the edge platform, the historical data values by at least one of the supervisory computer or the peripheral device to generate evaluation results;
generating, by the edge platform, user interface data comprising at least one of the historical data values or the evaluation results;
transmitting, by the edge platform, the user interface data; and
receiving, by a cloud platform, the user interface data from the edge platform and provide the user interface data to a user device, the user interface data causing the user device to display a graphic representation of the oil and gas metering subsystem.

18. The one or more non-transitory computer readable media of claim 17, wherein evaluating the historical data values comprises:
generating a plurality of different operating scenarios for operating equipment of the oil and gas subsystem for the plurality of historical times; and
simulating a plurality of values of data points of the oil and gas subsystem for the plurality of historical times based on the plurality of different operating scenarios and the historical data values.

19. The one or more non-transitory computer readable media of claim 17, wherein evaluating the historical data values comprises:
generating a plurality of performance scores for a plurality of different operating scenarios based on at least one of the historical data values of the plurality of data points or the evaluation results; and
determining a future recommendation for the oil and gas metering subsystem based on the plurality of performance scores for the plurality of different operating scenarios.

20. The one or more non-transitory computer readable media of claim 17, wherein evaluating the historical data values comprises comparing a measured output of the historical data values with a desired output;
wherein generating the user interface data comprises issuing a notification in response to the measured output being at least three standard deviations from the desired output.
